(19) United States
(12) Patent Application Publication
(10) Pub. No.: US 2026/0350568 A1
(43) Pub. Date: Nov. 5, 2026

(54) TRACKING AND PUBLICATION OF ASSETS ON BLOCKCHAIN OR DISTRIBUTED LEDGER

(71) Applicant: Howlite IP, Hunting Valley, OH (US)

(72) Inventors: Steven Harlan Rosen, Hunting Valley, OH (US); Anthony John Pyros, Miami, FL (US); Chandra Balasubramanian, Shaker Heights, OH (US); Himanshu S. Amin, Solon, OH (US)

(21) Appl. No.: 19/744,059

(22) Filed: Jul. 16, 2026

Related U.S. Application Data
(63) Continuation of application No. 18/067,518, filed on Dec. 16, 2022, now abandoned.
(60) Provisional application No. 63/292,037, filed on Dec. 21, 2021.

(51) Int. Cl. G06Q 20/10; G06Q 10/30; G06Q 20/06; G06Q 20/38

(52) U.S. Cl. CPC G06Q 20/108; G06Q 20/065; G06Q 20/105; G06Q 20/3829; G06Q 10/30; G06Q 2220/00

(57) ABSTRACT

One or more systems, devices, computer program products and/or computer-implemented methods of use provided herein relate to tracking and publication of assets on blockchain or distributed ledger. The computer-implemented system can comprise a memory that can store computer executable components. The computer-implemented system can further comprise a processor that can execute the computer executable components stored in the memory, wherein the computer executable components can comprise a payment component that can provide a payment platform that enables a payment instrument to be used for performing one or more financial transactions associated with a smart contract or a core API, wherein the smart contract or the core API is executed on a distributed ledger network that can operate on a hashgraph consensus, wherein the payment instrument is an financial instrument associated with a bank, and wherein the payment platform bridges web3 technology with traditional payment rails.

### CROSS-REFERENCE TO RELATED APPLICATIONS

This application is a continuation of U.S. patent application Ser. No. 18/067,518, filed on Dec. 16, 2022, entitled “TRACKING AND PUBLICATION OF ASSETS ON BLOCKCHAIN OR DISTRIBUTED LEDGER,” which claims priority to U.S. Provisional Patent Application Ser. No. 63/292,037, filed on Dec. 21, 2021, entitled “TRACKING AND PUBLICATION OF ASSETS ON BLOCKCHAIN OR DISTRIBUTED LEDGER.” The entireties of the aforementioned applications are incorporated by reference herein.

### TECHNICAL FIELD

The subject disclosure relates generally to tracking and publication of assets on blockchain or distributed ledger.

### BACKGROUND

Electronic transactions can be digitally recorded via blockchains or distributed ledgers. A blockchain can be a decentralized list of electronic blocks, where each electronic block contains a timestamp of one or more transactions, metadata characterizing the one or more transactions, and/or a cryptographic hash of the previous electronic block. Blockchain transactions are often slow and expensive due to poor design. Given the increasing prevalence of electronic transactions, improved systems are needed to track and publish assets.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable tracking and publication of assets on blockchain or distributed ledger are discussed.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise an execution component that can execute a smart contract or a core Application Programming Interface (API) on a distributed ledger network in response to one or more actions satisfying one or more predefined conditions based on the smart contract or the core API, wherein the distributed ledger network can operate on a hashgraph consensus. The computer executable components can further comprise a payment component that can provide a payment platform that can enable a payment instrument to be used for performing one or more financial transactions associated with the smart contract or the core API, wherein the payment instrument can be an existing financial instrument associated with a bank, and wherein the payment platform can bridge Web 3.0 (web3) technology with traditional payment rails.

According to another embodiment, a computer-implemented method is provided. The computer-implemented method can comprise executing, by a system operatively coupled to a processor, a smart contract or a core API on a distributed ledger network in response to one or more actions satisfying one or more predefined conditions based on the smart contract or the core API, wherein the distributed ledger network can operate on a hashgraph consensus. The method can further comprise enabling, by the system, a payment instrument to be used for performing one or more financial transactions associated with the smart contract or the core API, wherein the payment instrument can be an existing financial instrument associated with a bank, and wherein the payment instrument can be enabled by a payment platform that can bridge web3 technology with traditional payment rails.

According to yet another embodiment, a computer program product for providing a digital ledger technology (DLT) based payment platform is provided. The computer program product can comprise a non-transitory computer readable medium having program instructions embodied therewith, the program instructions executable by a processor to cause the processor to execute, by the processor, a smart contract or a core API on a distributed ledger network in response to one or more actions satisfying one or more predefined conditions based on the smart contract or the core API, wherein the distributed ledger network can operate on a hashgraph consensus. The program instructions can further cause the processor to enable, by the processor, a payment instrument to be used for performing one or more financial transactions associated with the smart contract or the core API, wherein the payment instrument can be an existing financial instrument associated with a bank, and wherein the payment instrument can be enabled by a payment platform that can bridge web3 technology with traditional payment rails.

### BRIEF DESCRIPTION OF THE DRAWINGS

FIG. 1 illustrates a high-level block diagram of an example, non-limiting system that can facilitate generation and utilization of block-chain or distributed ledger network related transactions in accordance with one or more embodiments described herein.

FIG. 2A illustrates a block diagram of an example, non-limiting embodiment of the distributed ledger network in accordance with one or more embodiments discussed herein.

FIG. 2B illustrates a block diagram of another example, non-limiting embodiment of the distributed ledger network in accordance with one or more embodiments discussed herein.

FIG. 2C illustrates a block diagram of yet another example, non-limiting embodiment of the distributed ledger network in accordance with one or more embodiments discussed herein.

FIG. 3 illustrates a block diagram of an example, non-limiting embodiment of the various use cases of a Howlite platform built upon the distributed ledger network in accordance with one or more embodiments discussed herein.

FIG. 4A illustrates a block diagram of an example, non-limiting use case of the distributed ledger network for publishing a will in accordance with one or more embodiments described herein.

FIG. 4B illustrates another block diagram of an example, non-limiting use case of the distributed ledger network for publishing a will in accordance with one or more embodiments described herein.

FIG. 5A illustrates a block diagram of an example, non-limiting use case of the distributed ledger network for publishing property liens in accordance with one or more embodiments described herein.

FIG. 5B illustrates another block diagram of an example, non-limiting use case of the distributed ledger network for publishing property liens in accordance with one or more embodiments described herein.

FIG. 6A illustrates a block diagram of an example, non-limiting use case of the distributed ledger network for academia in accordance with one or more embodiments described herein.

FIG. 6B illustrates another block diagram of an example, non-limiting use case of the distributed ledger network for academia in accordance with one or more embodiments described herein.

FIG. 7A illustrates a block diagram of an example, non-limiting use case of the distributed ledger network for hazardous waste (HW) material disposal and tracking in accordance with one or more embodiments described herein.

FIG. 7B illustrates another block diagram of an example, non-limiting use case of the distributed ledger network for HW material disposal and tracking in accordance with one or more embodiments described herein.

FIG. 8 illustrates a block diagram of an example, non-limiting use case of the distributed ledger network for HW material disposal, tracking and monetization in accordance with one or more embodiments described herein.

FIG. 9A illustrates an example, non-limiting view of a HowlCard in accordance with one or more embodiments described herein.

FIG. 9B further illustrates an example, non-limiting view of HowlCards in accordance with one or more embodiments described herein.

FIG. 10 illustrates an example, non-limiting embodiment of a Howlite application in accordance with one or more embodiments described herein.

FIG. 11 illustrates an example, non-limiting view of an embodiment of the HowlCard and the Howlite application in accordance with one or more embodiments described herein.

FIG. 12 illustrates an example, non-limiting embodiment of the distributed ledger network discussed herein in accordance with one or more embodiments described herein.

FIG. 13 illustrates an example, non-limiting flow diagram of interactions based on a Howlite payments platform ecosystem in accordance with one or more embodiments described herein.

FIG. 14 illustrates another example, non-limiting flow diagram of interactions based on a Howlite payments platform ecosystem in accordance with one or more embodiments described herein.

FIG. 15 illustrates a flow diagram of an example, non-limiting method in accordance with one or more embodiments described herein.

FIG. 16 illustrates an example, non-limiting computing environment in which one or more embodiments described herein can be implemented.

FIG. 17 illustrates an example, non-limiting networking environment in which one or more embodiments described herein can be implemented.

### DETAILED DESCRIPTION

The following detailed description is not intended to limit embodiments and/or application or uses of embodiments. Furthermore, there is no intention to be bound by any expressed or implied information presented in the preceding Background section, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Blockchain technology is widely regarded as a revolutionary, peer-to-peer, decentralized option for data organization. It allows for formation of decentralized monetary systems such as crypto-coins, smart contracts, and other resources that can be managed online, such as smart property. Blockchain can be used in distribute ledger systems and other financial transactions and allows different entities to exchange data and transactions quickly without intervention or verification by third parties. This can be accomplished through a shared data framework that utilizes computer algorithms to create real-time self-updates. Blockchain technology can also settle financial transactions without mediation from banks and other trusted institutions.

Smart contracts clarify and interpret relations regarding the blockchain and supply chain. Parties negotiate and agree on conditions-once the parties' conditions for an exchange are fulfilled, a smart contract is created, coded, and archived in a blockchain structure. Data can be recorded and managed through use of devices such as radio frequency identification device (RFID), quick-response codes, and wireless sensor networks (WSNs). Once the smart contract is created, goods and funds are transferred according to terms of the contract. No human mediation is required, and the transaction can proceed faster, and at less cost than a conventional paper-centric contract process. As most if not all participants in a network, associated with the transaction, have a copy of every transaction record, there is improved mutual trust.

A common framework for blockchain is a decentralized database in which transactions are recorded using a virtually unmodifiable cryptographic signature. Records can be added to the decentralized database to create blocks, that are protected against manipulation and alteration. Each block is connected to a previous block and has a timestamp. Different entities can create smart contracts based on a blockchain, without intervention from other entities. The data contained in such a smart contract is difficult to alter, as blocks cannot be changed after being formed. Thus, a smart contract on a blockchain can be a set of actions implemented on contributing nodes, creating mutual agreement in results of such transactions without need for third-party mediation of information and money.

In an example, parties negotiate and agree on conditions relating to a transaction. Once both parties' conditions for the exchange are fulfilled, a smart contract is created, coded, and archived in a blockchain structure. Data is recorded and managed (e.g., through use of Internet of Things (IoT) devices such as RFID, quick-response codes, and WSNs). Once the smart contract is created, goods and funds are transferred according to the terms of smart contract. No human mediation is required, and the transaction can proceed faster and at less cost as compared to non-blockchain transactions.

Electronic transactions can be digitally recorded via blockchains. A blockchain can be a decentralized list of electronic blocks, where each electronic block contains a timestamp of one or more transactions (e.g., the time at and/or about which such one or more transactions occurred), metadata characterizing the one or more transactions (e.g., amounts of cryptocurrencies involved in such one or more transactions, blockchain addresses from which and/or to which such amounts of cryptocurrencies were transferred during such one or more transactions), and/or a cryptographic hash of the previous electronic block. Because each electronic block can include a cryptographic hash of the previous electronic block, the blockchain can be resistant to retroactive tampering, which has led to a surge in the popularity of blockchain technology and a commensurate surge in the popularity of cryptocurrencies and increasing prevalence of electronic transactions involving smart contracts. However, as blockchain transactions and associated smart contracts become ubiquitous, the door is open to risk.

A recent advancement in blockchain technology relies on a hashgraph consensus algorithm developed by Hedera Hashgraph. The hashgraph consensus is a faster, more secure, and fair way of conducting transactions as opposed to traditional blockchain consensus such that the final consensus reached is abiding and documents are made available for public viewing on a public ledger. Hashgraph algorithms make it possible for transactions to be communicated via a more complex network as opposed to traditional blockchain, thereby providing an ideal interface for users to publish legally abiding contracts such as wills and liens, verify individuals' credentials for academic admissions, publish maintenance records for vehicles and track HW transportation such that they are perpetually available for public viewing in their most recent and accurate version.

In general, a smart contract can be computer code that automatically executes all or parts of an agreement and is stored on a blockchain-based platform. In an aspect, the smart contract (or code) can be the entirety of an agreement between parties. In another aspect, the smart contract can be code that implements certain provisions of a traditional written contract, e.g., moving funds between parties to the smart contract. The smart contract can be replicated across multiple nodes of a blockchain and, therefore, benefit from security, permanence and immutability associated with blockchain technology.

A smart contract can, for example, execute actions if pre-conditions are satisfied, or alternatively not execute certain actions if pre-conditions are not satisfied. As adoption of blockchain technology spreads, and as more assets are tokenized or go “on chain,” smart contracts can become increasingly complex and capable of handling sophisticated transactions. Consequently, certain provisions or policies of a given smart contract may leave a party at disadvantage or even vulnerable. Hedera Hashgraph can provide a simple interface for all parties involved to keep track of the who, what, and when of transactions so that consensus on contracts and other abiding documents can be reached in a fast and secure way.

With Hedera Hashgraph, the underlying hashgraph consensus relies on algorithms that allow participating parties to maintain a distributed ledger on their devices (e.g., computers, other electronic device), wherein the devices are typically referred to as nodes. Nodes communicate amongst each other, and the common ledger which is present on each node is constantly updated as transactions are carried out. Each node has a copy of the exact order of transactions wherein the algorithm also records the date and time of transactions. This is achieved via a gossip-about-gossip protocol and virtual voting wherein a copy of the updated public ledger with information about every transaction can be present and perpetually updated on each participating individual's node (e.g., computer, other electronic device) such that every node can have details about the transaction, a time stamp, a digital signature and two cryptographic hashes-one corresponding to the last message that was sent and one corresponding to the last message that was received by a respective node. Thus, each node can have access to information about every transaction, including when the transaction was updated and communicated to other nodes. The hashgraph framework can also ensure that parties involved in or having access to transactions are not able to manipulate sensitive information. In this manner, Hedera Hashgraph provides a very transparent network which makes way for several potential uses.

Hedera Hashgraph can enable an orchestration platform (Howlite Hedera platform) by Howlite such that end users can utilize a Howlite Hedera network to publish wills, trusts, liens, publish diplomas and accreditation certificates, track the flow of HW, and maintain records on vehicles and equipment, including airplanes, trucks, boats, industrial machinery, etc. via DLT, wherein the terms of the contract can form the smart contract architecture. The smart contract can be designed such that when the conditions of the contract are updated or if errors are identified in process management by the algorithm, the contributing parties are notified/alerted, and the most recent state of transactions is available much more quickly and transparently to all via the Howlite Hedera network. Since the hashgraph consensus uses a gossip-about-gossip protocol, each node is always talking to other nodes and has information about communication between all other nodes, so that when all parties agree on the order of transactions, it can eliminate any dispute about the finality of a document. In an embodiment, node operators can make money for processing consensus messages.

In an embodiment, a party desires to publish a will which allocates funds and assets to several individuals, as wills commonly do. The will could have clauses which state that allocations are to be made once individuals reach a specific age or once certain qualifying life events have taken place. As such, inheriting parties can also stand a chance of losing part or all of their share in the will if they don't meet the criteria, for example, if the criteria is to reach a specific age. The will can be published as a smart contract on the Howlite Hedera network such that the participating parties can comprise the publisher of the will, allocating institutions, if any, and the inheriting parties.

As and when inheriting parties individually reach the point of asset acquisition due to qualifying life events, the will can be executed. Without the use of Hedera Hashgraph, a third party such as an attorney may need to be involved in the process which can indicate an added cost. Further, without the added security of Hedera Hashgraph, documents can be tampered with. On the Howlite Hedera network, since all communication is transparent, foul-play can be eliminated since all parties need to agree upon the order of transactions before the will or any portion of it can be executed, in accordance with the virtual voting feature of Hedera mentioned earlier. Additionally, without the need for a third party, there can be time and cost savings. Once a consensus on the finality of the will is reached, it can become available for public viewing on the public ledger.

The same concept can apply to trusts and other types of contracts involving inheritance of any kind. Where direct monetary allocation is involved, it can be possible to make use of Hedera's cryptocurrency known as HBAR or use Hedera Token Service (HTS) to enable payments via Hedera's native tokens. Such functionality can be invaluable for both fungible and non-fungible assets. In an embodiment, Stablecoin can be pegged to USD on Hedera to enable a similar functionality, and the embodiment can be accomplished using HTS.

In a different embodiment, the hashgraph consensus can be utilized to publish liens for properties including homes, cars, boats, and other valued assets. This embodiment can provide for a very convenient interface for lending institutions and borrowers to keep track of property ownership and monitor assets. Bad actors on either side of a transaction can be checked and wrongdoing can be mitigated or prevented. Where multiple nodes of lending and borrowing parties are involved, the Hedera Consensus Service (HCS) can be employed to preserve an immutable log of messages for future referencing due to frequency of transactions. This can simplify tracking of assets wherein logs would have fair consensus and a trusted timestamp.

In yet another embodiment, the Howlite Hedera network can be utilized in academia for schools and colleges that need to verify students' credentials. This embodiment can provide a platform where academic institutions could have incoming students' credentials available for verification without need for a litany of documents and attestations. An application could be developed solely for the purpose of accreditation verification using the Hedera consensus. Students and scholars applying to academic institutions or applying for financial assistance and scholarships can upload credentials required by the academic institutions. Other parties that can legitimately verify a student's diploma, qualification and/or financial need can act as nodes and a consensus can be reached within very little time. In this embodiment, fraud can be prevented in the case where students might be inauthentically trying to secure a place in an academic program or trying to secure financial assistance where someone else can benefit from the same. This embodiment can provide students greater authority over their credentials and skills both, in terms of who the information is shared with, and in terms of the legitimacy of their credentials, while providing academic institutions the right to revoke.

Presently, several universities rely on hard copies of diplomas and credentials which can often require attestations from prior academic institutions (e.g., high schools) and physically mailing documents, which can be tedious, and documents can be lost or misplaced in the process. Where international academic institutions are involved, there can be a greater opportunity for fraud since the qualifying body in one country may not be entirely familiar with admissions procedures in other countries. By employing the hashgraph consensus, the above issues can be addressed, and since academic institutes around the world can function differently in terms of admission procedures, it can also be possible to standardize admissions procedures. Furthermore, this embodiment can eliminate admission scams, especially with private and ivy league institutes, as was recently the case with the 2019 scandal wherein an investigation code named Operation Varsity Blues exposed a criminal conspiracy worth millions of dollars to influence undergraduate admissions scams at several top universities in the United States.

In this embodiment, HCS can assist with the high-volume aspect of academic transactions while maintaining a transparent record of communications. With the use of HBAR (the underlying crypto token for Hedera Hashgraph), scholarships can be managed more easily wherein students can use cryptocurrency to purchase books or other supplies as required for their major of study. For example, an academic institute can maintain a log of transactions in connection with a student's academic performance and revoke a scholarship if a student fails to maintain a grade point average (GPA) scored required for the scholarship to continue. Further in this embodiment, Howlite payments (e.g., Howlite payments platform, etc.)/HowlCard can be used, in addition to HBAR. HowlCard can be a payment acceptance mark, or it can be a transparent routing mechanism for other payment acceptance marks such as Visa, MasterCard, etc.

In yet another embodiment, the Howlite Hedera platform can be applied to HW tracking and management. According to the Environmental Protection Agency (EPA), HW can comprise waste with properties that can make it dangerous or capable of having a harmful effect on human health or the environment. HW can comprise household waste, pharmaceutical and radioactive waste, etc. and HW can appear in multiple different forms. Thus, in addition to proper disposal of HW, safe transportation and tracking of such waste from a generator facility to a waste management facility is vital.

By incorporating the one or more subject embodiments discussed herein, concerned parties from waste generation, transportation and management facilities can easily track status of waste at individual checkpoints and checkpoints can be added to a construct algorithm of the Howlite Hedera network as required. Each transaction within such a network can be monitored transparently by all parties involved and errors in management can be quickly highlighted. For example, a waste management facility can expect a shipment of waste chemicals by 5:00 μm on a given day, and in an event that the shipment of waste chemical is not received on schedule, the concerned individuals at the waste management facility can withhold communicating a transaction on the Howlite Hedera network which would otherwise signal the completion of the activity, thus alerting the concerned parties of gaps in the process.

Similarly, alerts can be built into the construct algorithm or code for improper disposal of waste and to reduce carelessness in transportation of the HW. As in the previous examples, a log of the tracking process can be maintained, and since the hashgraph consensus can automatically generate time stamps for activities, no additional communication about the timing of dispatch, receiving, or anything in between, is required. Hedera can also be used to train HW transporters on waste delivery and tracking wherein a smart contract can have steps that need to be completed before a training is considered complete and a consensus on the training score can be reached via virtual voting.

In another embodiment, the Howlite Hedera network can be utilized towards maintaining records on vehicles and equipment which can include information comprising ownership, operators of and operations of a vehicle, machinery or other equipment, information on purchasing or leasing, as well as useful lifecycle of the vehicle or machinery, or other equipment. Businesses can use such data logs to prove their credibility to customers where suitable.

Hedera can offer a very user friendly, secure, fast and non-proprietary environment to all with features such as tokenization, data compliance and permissioned blockchains, to name a few. With inclusion of HBAR and a HowlCard (or HCard), a financial aspect of contracts can also be taken care of, thereby turning Hedera into an online marketplace. In an embodiment, HowlCard can be a payment card enabled by a Howlite payments platform (Howlite) which can be issued to individuals and businesses to transact with other businesses. Existing cards (e.g., credit cards, debits cards, etc.) issued by financial institutions can be enabled to work with the Howlite Payments Platform (“Howlite Enabled”). Business-to-consumer (B2C), business-to-business (B2B), multiparty B2B transactions, etc. can be cost effectively enabled due to fixed transaction fees on the Howlite payments platform. The Howlite payments platform can provide a payment infrastructure that can bring the advantages and benefits of web3/Distributed Ledger Technology (DLT), such as security, transparency and cost efficiency, to traditional mainstream payments familiar to consumers and businesses. While web3 and DLT can bring tremendous value to a payments ecosystem, the end user experience can be less than ideal for end users not familiar with the nuances of web3 technologies. In addition, transaction fee structures can be antiquated, expensive, and slow in some cases. Large scale merchants (e.g., Walmart and Target) have been recently known to push for a credit-card fee law to reduce swipe fees for end users of Visa Inc. and Mastercard Inc., for example.

Howlite payments platform can work in conjunction with the hashgraph consensus of Hedera Hashgraph, wherein Hedera Hashgraph is a DLT with processing and throughput capabilities required for largescale transactions (e.g., Hedera currently has about 1,000,000 (~1M) accounts, while the actual number of physical people holding HBars can be far greater due to HBars purchased using custodian accounts such as Binance®, Crypto.com, etc.). With assistance of well-known payment standards such as EMVCo Rails and ISO standards, HowlCard with IINs (Issuer Identification Numbers) can achieve quick acceptance in the payment world by allowing for reserving a universally accepted number prefix in the payment world, and the HowlCard can be issued to Hedera account holders. In addition to the HowlCard issued and enabled to work on Howlite Payments Platform, other payment cards/instruments issued by financial institutions (e.g., Visa or MasterCard payment card issued by a bank) can be enabled to work on the Howlite payments platform which can allow Howlite to facilitate issuers & merchants compliance with Regulation II for the Durbin Ammendment. Further, identity authentication can be enabled natively based on how public/private keys work with Hedera natively. This concept can be overlayed to use for FaceId/TouchId, Fast ID Online (FIDO), etc. HowlCards can be stand alone or scale to other banks, funded by HBAR, Hedera tokens or fiat money (e.g., balance transfer from fiat money). The funds can be kept in HBAR currency and credit evaluation can be underwritten using underwriter or SoFi/decentralized financing (DeFi).

HowlCard in conjunction with HBAR can have immense benefits for executing wills, funds transfer for liens, university scholarships and financial student assistance, and for payments to waste transport and management facilities. This is especially true since funds transfer is natively supported between Hedera account holders and multi-party payments can be enabled natively for multi-buyer/single-seller, single-buyer/multi-seller (e.g., Online Travel Agencies (OTAs)), multi-buyer/multi-seller use cases. The Howlite Hedera network can be fast and eliminate middlemen, and it can be possible to issue HowlCards at a small fee with lower processing costs for HBAR transfer. With real time payments (RTP) gaining prominence, HowlCards can be suitable for large amounts of money since the pricing would be based on a fixed fee versus a percentage of the value. Real-time funds settlement would constitute great benefits where, for example, inheritance is due and assets are fungible, due to lower processing costs and suitability for high financial transactions. The feature of large money transfer could also be used in academia-related use cases, for example, to pay college tuition to secure a seat in a program, once a student's accreditation is verified, as discussed in one or more embodiments herein.

The Howlite Hedera network can also minimize or streamline arbitration and chargeback processing time with well-designed consensus services tracking on Hedera and smart contracts, further assisting with the financial transaction side of DLT. HCS DLT are compliance and regulatory friendly and HTS can be used natively to enable payment tokens for HowlCards. Funds settlement can be near real time between buyer and seller. HowlCards can also provide improvements in cost for small to medium businesses and even the largest of businesses. For example, currently, card transactions' average order value (AOV) is about $150. Amazon pays 1.3-1.4% while SMB's pay 3-5%. Below that is 1% of ticket amount or $0.02 per transaction. HowlCard fees can be further reduced.

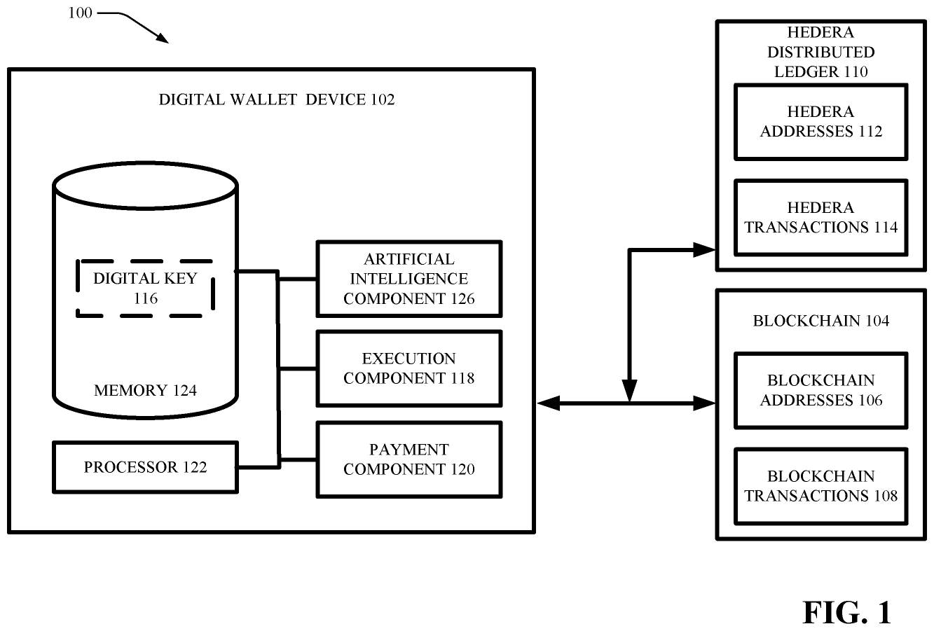

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1900 illustrated at FIG. 19. In one or more described embodiments, computer and/or computing-based elements can be used in connection with implementing one or more of the systems, devices, components and/or computer-implemented operations shown and/or described in connection with FIG. 1 and/or with other figures described herein.

One or more embodiments described herein can include systems, computer-implemented methods, apparatus, and/or computer program products that can facilitate publishing, tracking and asset transfer on blockchains or the Hedera network. In other words, various embodiments described herein can include a computerized tool (e.g., any suitable combination of computer-executable hardware and/or computer-executable software) that can electronically receive inputs.

FIG. 1 illustrates a high-level block diagram of an example, non-limiting system 100 that can facilitate generation and utilization of blockchain or distributed ledger network related transactions in accordance with one or more embodiments described herein.

Discussion first turns briefly to processor 122 and memory 124 of non-limiting system 100. For example, in one or more embodiments, the system 100 can comprise processor 122 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 122 to enable performance of one or more processes defined by such component(s) and/or instruction(s).

In one or more embodiments, system 100 can comprise a computer-readable memory (e.g., memory 124) that can be operably connected to the processor 122. Memory 124 can store computer-executable instructions that, upon execution by processor 122, can cause processor 122 and/or one or more other components of system 100 (e.g., execution component 118, payment component 120 and/or artificial intelligence (AI) component 126) to perform one or more actions. In one or more embodiments, memory 124 can store computer-executable components (e.g., execution component 118, payment component 120 and/or AI component 126).

System 100 and/or a component thereof as described herein, can be communicatively, electrically, operatively, optically and/or otherwise be coupled to one another via a bus (not shown). The bus can comprise one or more of a memory bus, memory controller, peripheral bus, external bus, local bus, and/or another type of bus that can employ one or more bus architectures. One or more of these examples of the bus can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 122 and/or memory 124 described above, system 100 can comprise one or more computer and/or machine readable, writable and/or executable components and/or instructions that, when executed by processor 122, can enable performance of one or more operations defined by such component(s) and/or instruction(s). System 100 can be associated with, such as accessible via, a computing environment 1900 described below with reference to FIG. 19. For example, system 100 can be associated with a computing environment 1900 such that aspects of processing can be distributed between system 100 and the computing environment 1900.

As shown, a digital wallet device 102 can be electronically integrated, via any suitable wired and/or wireless electronic connection, with a blockchain 104. In various aspects, the blockchain 104 can be any suitable type of blockchain in which a set of blockchain addresses 106 can be electronically recorded/documented and/or in which a set of blockchain transactions 108 can be electronically recorded/documented. In various instances, the set of blockchain addresses 106 can include any suitable number of blockchain addresses. Similarly, the set of blockchain transactions 108 can include any suitable number of blockchain transactions. In various instances, the set of blockchain transactions 108 can have occurred between and/or among the set of blockchain addresses 106. Accordingly, the blockchain 104 can be considered a digital record of the set of blockchain transactions 108 in which the set of blockchain addresses 106 participated. Likewise, the Hedera distributed ledger 110 can be any suitable type of distributed ledger in which a set of Hedera addresses 112 can be electronically recorded/documented and/or in which a set of Hedera transactions 114 can be electronically recorded/documented. In various instances, the set of Hedera addresses 112 can include any suitable number of addresses. Similarly, the set of Hedera transactions 114 can include any suitable number of transactions. In various instances, the set of Hedera transactions 114 can have occurred between and/or among the set of Hedera addresses 112. Accordingly, Hedera distributed ledger 110 can be considered a digital record of the set of Hedera transactions 114 in which the set of Hedera addresses 112 participated.

More specifically, the blockchain 104 or Hedera distributed ledger 110 can be a decentralized digital ledger made up of a sequence of electronic blocks. In various instances, any given electronic block can include a timestamp (e.g., time and/or date) associated with one or more blockchain transactions (e.g., some of the set of blockchain transactions 108). In various cases, the given electronic block can also include metadata pertaining to the one or more blockchain transactions, such as amounts and/or types of cryptocurrencies involved in the one or more blockchain transactions, and/or such as one or more blockchain addresses (e.g., some of the set of blockchain addresses 106) to which and/or from which such amounts and/or types of cryptocurrencies were transferred. In some cases, the given electronic block can further include metadata pertaining to the one or more blockchain addresses, such as age of a blockchain address (e.g., days, months, and/or years since registration and/or creation of the blockchain address) and/or number of smart contract tokens obtained by a blockchain address. Moreover, in various aspects, the given electronic block can include any suitable cryptographic hash of the preceding electronic block. In various instances, because each electronic block in the blockchain 104 can include a cryptographic hash of the previous electronic block, the blockchain 104 can be resistant to retroactive tampering and/or falsification. The Hedera distributed ledger 110 can work in a similar manner with greater trust, speed and at lower costs than conventional blockchains.

A cryptocurrency wallet can be a piece of software that keeps track of secret keys (digital keys) used to digitally sign cryptocurrency transactions for distributed ledgers. Because those keys are the only way to prove ownership of digital assets- and to execute transactions that transfer them or change them in some way-they are critical piece of the cryptocurrency ecosystem. Not only does a crypto wallet (or more generically, a digital wallet device 102) keep track of encryption keys used to digitally sign transactions, it also stores the address on a blockchain or distributed ledger where a particular asset resides. The digital wallet device 102 can store the underlying piece of code that effectuates the crypto wallet (or digital wallet). The digital wallet device 102 can be a suitable storage device, e.g., mobile device, cellular phone, cold storage device, personal computer, server, laptop computer, special purpose computing device, etc. There are two main types of crypto wallets: hardware and software (also known as cold and hot storage wallets, respectively). Hot storage wallets are accessible via an internet service (e.g., Coinbase®, UpHold®, Voyager®, Binance®, etc.) and these can be further segregated into online wallets and client-side wallets (e.g., managed locally on a user's computer or mobile device). It is to be appreciated that the subject innovations are not intended to be limited to implementations within the context of client-side, hardware-based wallets. Accordingly, in addition to client-side, hosted, proxied, distributed, hybrid or cloud-based implementations/embodiments of the digital wallet device 102 are contemplated.

Cold storage wallets are typically downloaded and reside offline on hardware, e.g., universal serial bus (USB) drive or smart phone. Cold storage wallets can also be purchased as devices with crypto-wallet software already installed therein. Cold storage wallets are in general more secure than hot wallets due to not being continuously (or often) connected to the internet. However, if information on a cold wallet is not backed up or a hard copy thereof not stored in a secure location, and the cold wallet is lost, the digital assets stored thereon can be non-recoverable. In other words, one no longer knows where the crypto assets reside on a blockchain or have respective keys to authenticate the true owner. Hot storage wallets have a benefit of service provider support. The service provider can provide mechanisms for recovering lost keys (e.g., challenge and answer questions). Hardware wallets can be further divided into crypto-assist type wallets that handle keys and signing of arbitrary data and are often referred to as hardware security modules (HSMs). There are other types of hardware wallets (e.g., digital wallet device 102) that handle generating and signing complete transactions that are then sent to a distributed ledger network.

While a vast majority of crypto wallet applications can be used to store cryptocurrencies (e.g., HBAR, Etherium, BitCoin, etc.), the software can also store digital keys to fungible and non-fungible digital tokens (NFTs) representing goods, financial assets, securities, and services (e.g., a token stored in a digital wallet can represent tickets to an event or for travel, artwork, most anything with digital value associated therewith). Distributed ledgers with decentralized consensus mechanisms rely on a capability security model, wherein possession of an encryption key proven with a digital signature over a transaction can authorize the action the transaction represents. Thus, applications modeled on a distributed ledger can require users to have wallets that they use to sign transactions that work for respective applications. Given near invisibility of users in such transactions, a robust means for authenticating user(s) is highly desirable.

It is to be appreciated that computer operations and efficiency are improved by the prevention of a potentially fraudulent blockchain/digital ledger network transaction. A fraudulent transaction can be an unnecessary transaction (e.g., one the user would not willingly engage in). This transaction can require computing power, memory usage, energy usage, and network usage by the user's computer system, all of which can be conserved if the user does not participate in the transaction. This energy usage can also be conserved through respective blockchain or distributed ledger transactions being authentic or authenticated with appropriate methods.

As discussed in various embodiments, the digital wallet device 102 can comprise processor 122 (e.g., computer processing unit, microprocessor) and a computer-readable memory (e.g., memory 124) that is operably and/or operatively and/or communicatively connected/coupled to the processor 122. The memory 124 can store computer-executable instructions which, upon execution by the processor 122, can cause the processor 122 and/or other components of the digital wallet device 102 to perform one or more acts. In various embodiments, the memory 124 can store computer-executable components, and the processor 122 can execute the computer-executable components.

In various embodiments, the digital wallet device 102 can electronically receive and/or retrieve, via any suitable data communication and/or data querying technique, the blockchain 104 or Hedera distributed ledger 110 from such databases and/or computing devices. That is, the digital wallet device 102 can electronically access the blockchain 104 or Hedera distributed ledger 110, such that other components of the digital wallet device 102 can electronically read, parse, and/or otherwise interact with the blockchain 104 or Hedera distributed ledger 110.

In various embodiments, AI component 126 can utilize machine learning techniques, that can employ a model (explicitly or implicitly trained) to learn transactions, rules, preferences, smart contracts, regulations, etc., and facilitate authenticating users. AI component 126, for example, can be trained on prior historical data to identify and authenticate users, execute or deny transactions, monitor events or conditions and take automated action at desirable confidence levels (e.g., 99.99% confidence), or above any desired confidence threshold. AI component 126 can, in an embodiment, build and continuously train a model that can facilitate carrying out functions of respective embodiments described herein. For example, different transactions can require respectively different confidence thresholds in order to be authorized. For example, depending on ranges of dollar value for respective transactions the confidence levels can vary. A high value transaction can for example require a greater confidence level whereas a low value transaction can require a relatively lower confidence level to be authorized. The AI component 126 can perform such analyses in connection with one or more embodiments herein to authorize transactions.

DeFi is a blockchain-based form of finance that does not rely on central financial intermediaries such as brokerages, exchanges, or banks to offer traditional financial instruments, and instead utilizes smart contracts on blockchains (e.g., Ethereum). DeFi platforms can facilitate people to lend or borrow funds from others, speculate on price movements on a range of assets using derivatives, trade cryptocurrencies, insure against risks, and earn interest in savings-like accounts. DeFi is centered around decentralized applications (DApps), that perform financial functions on distributed ledgers (e.g., blockchains). Rather than transactions being made through a centralized intermediary such as a cryptocurrency exchange or a traditional securities exchange on Wall Street, transactions are directly made between participants, mediated by smart contract programs.

These smart contract programs, or DeFi protocols, can typically run using open-source software that is built and maintained by a community of developers. DApps can be typically accessed through a web3 enabled browser extension or application, such as MetaMask, which can allow users to directly interact with a blockchain through a digital wallet. Coding errors and hacks can be common in DeFi. Blockchain transactions can be irreversible, which can imply that an incorrect or fraudulent transaction on a DeFi platform cannot be easily corrected. In year 2020, one platform known as Yam Finance quickly grew its deposits to $750 million before crashing days after launch due to a code error. Additionally, the code for the smart contracts that implement DeFi platforms is generally open-source software that can be easily copied to set up competing platforms, which can create instabilities as funds shift from platform to platform. The person or entity behind a DeFi protocol may be unknown and may disappear with investors' money. Accordingly, the AI component 126 can facilitate protecting users from entering into smart contracts by monitoring such pitfalls.

To facilitate some of the above-described machine learning aspects of various embodiments of the subject innovation, consider the following discussion of AI. Various embodiments of the present innovation herein can employ AI to facilitate automating one or more features of the present innovation. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) of the present innovation, components of the present innovation can examine the entirety or a subset of the data to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined actions related to claimed subject matter. Thus, classification schemes and/or systems can be used to automatically learn and perform a number of functions, actions, and/or determinations.

A classifier can map an input attribute vector (e.g., z=(z₁, z₂, z₃, z₄, . . . , zₙ)), to a confidence class that the input belongs to (e.g., f(z)=confidence(class)). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In some embodiments, execution component 118 can execute a smart contract or a core API on a distributed ledger network in response to one or more actions satisfying one or more predefined conditions based on the smart contract or the core API, wherein the distributed ledger network operates on a hashgraph consensus (e.g., Hedera Hashgraph). Hedera Hashgraph, in addition to supporting a smart contract can also support other native functions (e.g., core APIs, other similar mechanisms, etc.) to achieve similar results. In an embodiment, the smart contract or the core API can be a will or trust published on the Hedera network. In another embodiment, the smart contact or the core API can be a property lien published on the Hedera network. In yet another embodiment, the smart contract or the core API can be a training manual comprising steps that can be used to train individuals for HW management. Payment component 120 can provide a payment platform that can enable a payment instrument to be used for performing one or more financial transactions associated with the smart contract or the core API, wherein the payment instrument can be an existing financial instrument (e.g., credit card, debit card, checking account, savings account, etc.) associated with a financial institution (e.g., bank), and wherein the payment platform can bridge web3 technology with traditional payment rails.

In an embodiment, the payment instrument can enable transaction fees associated with the one or more financial transactions to fall below a defined threshold. In an embodiment, the payment instrument can be a payment card (e.g., HowlCard) associated with a new account on the payment platform (e.g., Howlite payments platform). The payment instrument can allow funds associated with the one or more financial transactions to be settled in real-time such that at least one entity can move fiat money from a first financial account to a second financial account based on instructions to settle the funds, and the payment instrument can be funded via cryptocurrency (e.g., BitCoin, Ethereum, etc.) or fiat money. The payment platform (e.g., Howlite payments platform) can allow merchants to retain and maintain existing business operations while enabling regional financial regulations, and the payment platform can allow consumers to authorize the one or more financial transactions using native device capabilities. In an embodiment, the payment platform can provide an HW disposal and tracking platform via one or more application programming interfaces (APIs) to entities involved in a hazardous waste generation and disposal chain. These embodiments are described in greater detail with respect to one or more figures herein.

Those having ordinary skill in the art will appreciate that the herein disclosure describes non-limiting examples of various embodiments of the subject innovation. For ease of description and/or explanation, various portions of the herein disclosure utilize the term “each” when discussing various embodiments of the subject innovation. Those having ordinary skill in the art will appreciate that such usages of the term “each” are non-limiting examples. In other words, when the herein disclosure provides a description that is applied to “each” of some particular computerized object and/or component, it should be understood that this is a non-limiting example of various embodiments of the subject innovation, and it should be further understood that, in various other embodiments of the subject innovation, it can be the case that such description applies to fewer than “each” of that particular computerized object.

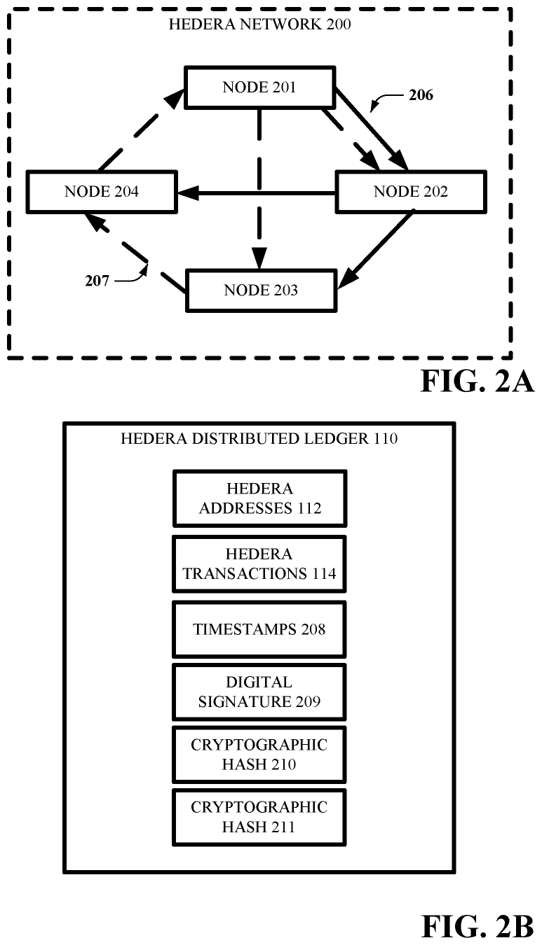

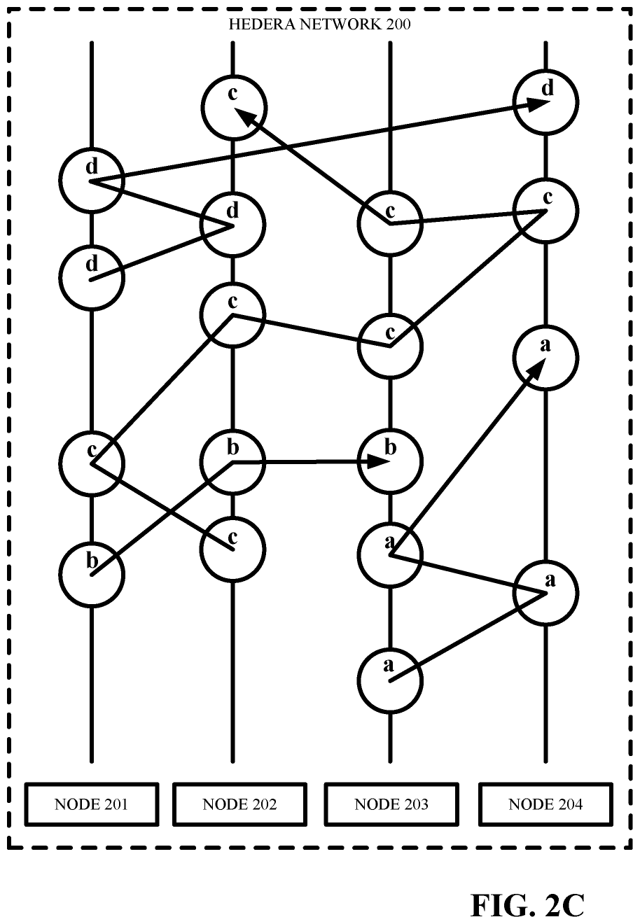

FIG. 2A illustrates a block diagram of an example, non-limiting embodiment of the distributed ledger network in accordance with one or more embodiments discussed herein. FIG. 2B illustrates a block diagram of another example, non-limiting embodiment of the distributed ledger network in accordance with one or more embodiments discussed herein. Repetitive description of like elements and/or processes employed in respective embodiments is omitted for sake of brevity.

The block diagram of FIG. 2A can comprise Hedera network 200 further comprising nodes 201, 202, 203 and 204 which can represent computers and/or other suitable electronic devices of participating individuals and/or groups of individuals or organizations on Hedera network 200. The arrows travelling between the nodes (e.g., nodes 201-204) can represent messages containing transactions that can be initiated between the nodes, and any node can initiate a transaction at any time. Hedera network 200 can also comprise Hedera distributed ledger 110 (FIG. 1) further comprising a set of Hedera addresses and transactions (e.g., Hedera addresses 112 and Hedera transactions 114 of FIG. 1), timestamps 208, digital signature 209, and cryptographic hashes 210 and 211. The block diagram of FIG. 2B illustrates Hedera distributed ledger 110.

Within Hedera network 200, message 206 (illustrated by solid lined arrows in FIG. 2A) comprising information about a transaction associated with execution of a will can be sent from node 201 to node 202, and node 202 can then communicate message 206 to nodes 203 and 204 (illustrated as arrows travelling from node 202). As messages are sent and/or received, details about each of these messages can be updated and recorded on the common ledger (e.g., Hedera distributed ledger 110) which is updated, recorded, and preserved in real-time on every other participating node. In this manner, each node on the network can have transparent information available about every transaction that can take place within Hedera network 200. Hedera distributed ledger 110 can comprise the set of Hedera addresses 112 which can include information about the addresses where message 206 was received and/or sent from. The set of Hedera transactions 114 can comprise information about the one or more transactions that can be contained within message 206, such as what the transaction was about and/or how much cryptocurrency was transferred, and the ledger can include additional information such as timestamps 208 for when message 206 was created, a digital signature 209 of an individual at node 201, and two cryptographic hashes. Cryptographic hash 210 can be a hash of the last message received by node 202, and cryptographic hash 211 can be a hash of the last message generated by node 202.

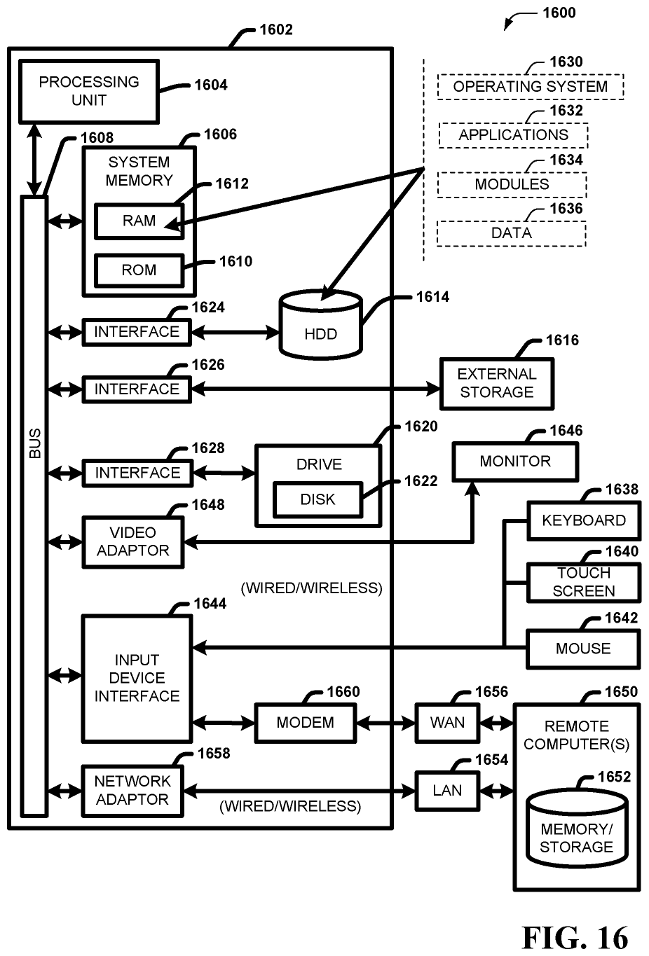

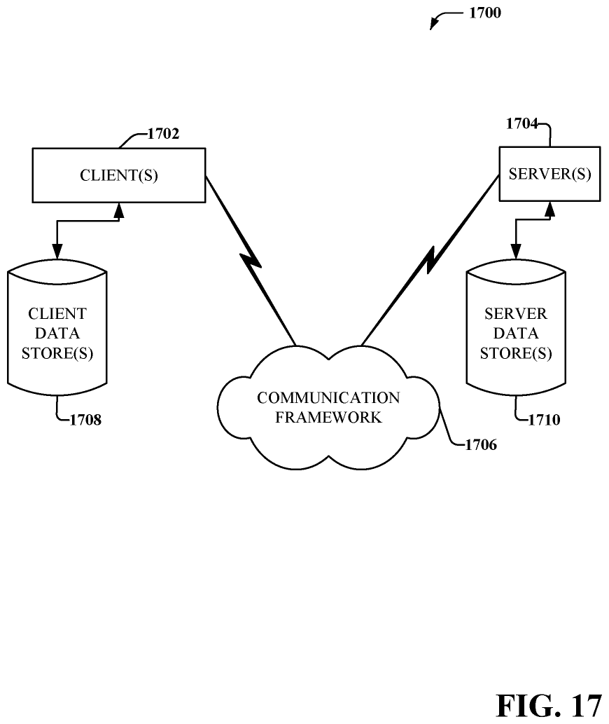

Within the Hedera network 200, message 207 (illustrated by dashed arrows in FIG. 2A) comprising information about another transaction associated with execution of the will can be sent from node 203 to node 204 and message 207, represented by broken line arrows, can originate before, after or at the same time as the message 206. Hedera distributed ledger 110 can store the same type of details about message 207 as it can about message 206. Thus, any node can initiate a message comprising a transaction (e.g., a financial transaction related to wills, trust, liens, etc.) at any time within Hedera network 200 and as one or more such messages travel between nodes, Hedera distributed ledger 110 can be updated on each node and all parties can be made aware of the state of every message and the corresponding transactions within the network. In an embodiment, Hedera network 200 can work in conjunction with a Howlite payments platform as elaborated in greater detail in relation to FIGS. 16 and 17.

FIG. 2C illustrates a block diagram of yet another example, non-limiting embodiment of the distributed ledger network in accordance with one or more embodiments discussed herein. Repetitive description of like elements and/or processes employed in respective embodiments is omitted for sake of brevity.

FIG. 2C comprises nodes 201, 202, 203 and 204 of FIG. 2A. Each traveling arrow can represent a different message, each column of circles can correspond to a node and each circle in any column can represent a point of communication when a message is sent and/or received by the node representing the column. For instance, an arrow that travels through circles marked “a” can represent a different message than an arrow that travels through circles marked “c”. Each circle marked “a” can represent each time a message was intercepted by the corresponding node, and it can also represent each time the Hedera distributed ledger 110 (FIGS. 1 and 2B) was updated with new information. As discussed in one or more embodiments herein, nodes 201, 202, 203 and 204 can initiate a message at any time within Hedera network 200, and Hedera network 200 can comprise additional nodes. In this manner, the Hedera network can function as a mesh as opposed to a blockchain.

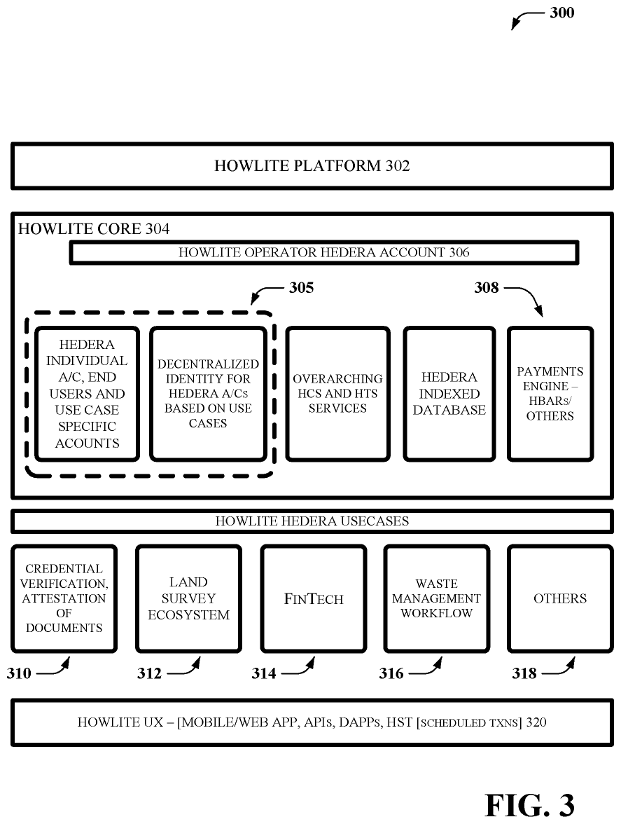

FIG. 3 illustrates a block diagram 300 of an example, non-limiting embodiment of the various use cases of a Howlite platform built upon the distributed ledger network in accordance with one or more embodiments discussed herein. Repetitive description of like elements and/or processes employed in respective embodiments is omitted for sake of brevity.

In one or more embodiments, Hedera Hashgraph can enable Howlite platform 302. Howlite platform 302 can be a payments and orchestration eco-system built on Hedera Hashgraph, wherein Hedera Hashgraph can provide the appropriate scale, speed, security and cost predictability for the payments and orchestration eco-system. Additionally, Howlite platform 302 can provide a payment infrastructure that can bring advantages and benefits of web3/DLT, primarily, security, transparency and cost efficiencies to traditional mainstream payments familiar to billions of consumers and millions of businesses. Traditional payment instruments such as credit/debit cards, bank accounts as well as cryptocurrencies held in various wallets and blockchains can be Howlite enabled to work seamlessly with Howlite platform 302 as well as their native platform. Howlite can provide a secure alternative routing capability to an existing payment instrument.

In one or more embodiments, Howlite platform 302 can enable Howlite operator Hedera account 306. Howlite operator Hedera account 306 and the various functionalities enabled by Howlite platform 302 are illustrated inside Howlite core 304. Howlite operator Hedera account 306 can be an account on Hedera Hashgraph belonging to a person, a group of persons and/or entities such as business or institutions. For example, at 305, Howlite platform 302 can work for individual Hedera Hashgraph accounts, end users and use case specific accounts as well as for decentralized identities for Hedera accounts based on specific use cases. Since Howlite platform 302 can be enabled by Hedera Hashgraph, Howlite platform 302 can provide the benefits of HCS and HTS services to end users. For example, as discussed in one or more embodiments herein, for situations involving direct monetary allocations, it can be possible to make use of Hedera's cryptocurrency known as HBAR or use HTS to enable payments via Hedera's native tokens. Such functionality can be invaluable for both fungible and non-fungible assets. For example, for situations involving multiple nodes of lending and borrowing parties, HCS can be employed to preserve an immutable log of messages as a hedera indexed database. At 308, Howlite platform 302 can provide a payments engine to enable financial transactions using Hedera's native crypocurrency, HBAR, Hedera Tokens equated to fiat currencies, or other cryptocurrencies. Alternatively, Howlite platform 302 can carry payment instructions using Hedera to financial institutions to perform the funding.

In one or more embodiments, Howlite platform 302 based on Hedera Hashgraph (Howlite Hedera platform) can enable various use cases. At 310, Howlite platform 302 can be used to verify credentials and attest documents (e.g., diplomas, wills, legal documents, etc.). For example, academic institutions such as universities can require incoming students to publish their credentials (e.g., diploma certificates) on a private Howlite Hedera network for verification without need for a litany of documents. It can even be possible for responsible individuals to attest the credentials for acceptance by the academic institutions. At 312, the Howlite platform 302 can enable a land survey eco-system. For example, a land survey can be published on a Howlite Hedera network by a land surveyor to assist a civil engineer with determination of a survey point, to assist potential buyers with discovery/purchase of land, to assist landowners with title insurances for their land, etc. Howlite platform 302 can assist with the financial aspect of the use cases discussed herein, although the use cases are not limited to the ones discussed herein.

At 314, financial technology (FinTech) based applications (e.g., regulations-based whitelisting for payment transactions, micropayments, tokenizations, etc.) can be enabled by Howlite platform 302. At 316, Howlite platform 302 can enable a waste management workflow (e.g., forms recording, workflow recording, access to agencies, etc.). At 318, Howlite platform 302 can provide a payment eco-system to several other use cases, not limited to the areas discussed with reference to FIG. 3. One or more of the use cases discussed herein are elaborated in greater detail in the subsequent figures. Howlite platform 302 can be accessed by end users via Howlite user experience (UX) 320, wherein Howlite UX 320 can represent smartphone/web applications, APIs, DAPPs, Hedera scheduled transactions (HST), etc. APIs can be offered to developers for front end e-commerce networks.

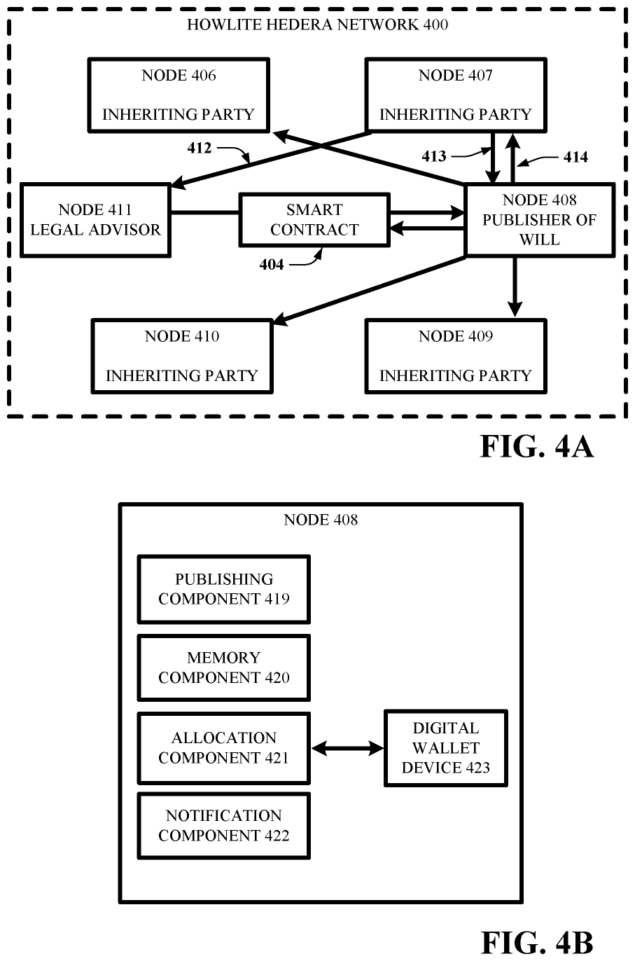

FIG. 4A illustrates a block diagram of an example, non-limiting use case of the distributed ledger network for publishing a will in accordance with one or more embodiments described herein. FIG. 4B illustrates another block diagram of an example, non-limiting use case of the distributed ledger network for publishing a will in accordance with one or more embodiments described herein. Repetitive description of like elements and/or processes employed in respective embodiments is omitted for sake of brevity.

In one or more embodiments, Howlite Hedera network 400 can comprise smart contract 404, nodes 406-411, and transactional messages including message 412, message 413 and message 414. Hedera Hashgraph can be used to publish a will and allocate funds or property to one or more inheriting parties as part of Howlite Hedera network 400. Each concerned party can assume a node within the network and each node can communicate with every other node in the network using a gossip-via-gossip protocol, as stated in one or more embodiments herein. Node 406, node 407, node 409 and node 410 can respectively belong to four individual inheriting parties, and each node can be a computer or a computing system (e.g., system 100). Node 408 can belong to a publisher of the will and node 411 can belong to a legal advisor such as an attorney or other legal professional. Although one of the benefits of Hedera Hashgraph is that it can eliminate the need for middlemen such as legal advisors, their involvement in a scenario, if necessary, can still be more cost and time efficient within a Howlite Hedera network.

In the current embodiment, the will can be published as smart contract 404 on Howlite Hedera network 400 via node 408. If an inheriting party at node 407 becomes eligible for their share of inheritance due to a qualifying life event, transactions can be initiated from node 407 to nodes 411 and 408 as respective messages 412 and 413 to notify the legal advisor and publisher of the will. The legal advisor and publisher can provide an authorization to execute the will or a portion of the will, and node 408 can send a message 414 to node 407 which can comprise a notification and transfer of cryptocurrency equivalent to their share of inheritance, if applicable. In addition, node 408 can send out messages to other inheriting parties notifying them of the transaction, and the common Hedera distributed ledger can be updated on each node to reach consensus.

Node 408 can comprise a publishing component 419, memory component 420, allocation component 421, notification component 422, and digital wallet device 423. Some or all these components and devices can be present on other participating nodes of Howlite Hedera network 400. Publishing component 419 can assist in converting a will to smart contract 404. Memory component 420 can update and record the Hedera distributed ledger for Howlite Hedera network 400 as new transactions occur. Allocation component 421 can be connected to a digital wallet device 423 which is similar to digital wallet device 102 of FIG. 1, wherein digital wallet device 423 can be a cold-storage device or a hot-storage device. Allocation component 421 can receive and store assets as HBAR cryptocurrency in digital wallet device 423, and it can draw cryptocurrency from digital wallet device 423 for transferring funds as inheritances or as payments to node 411 for legal advice associated with any transactions. The use of HTS can further assist in the tokenizing of fungible and non-fungible assets for allocating inheritances.

Further, Hedera Hashgraph can enable a Howlite payments platform that can further enable a HowlCard or an existing payment instrument (e.g., credit card, debit card, bank account, etc.) to be used for conducting one or more financial transactions (e.g., withdrawal of money) associated with an inheritance. Notification component 422 can receive and send out notifications and alerts to and from node 408 in case a clause in the will is to be executed. It is to be appreciated that the publishing of a will on a Howlite Hedera network is an exemplary embodiment, and the innovations discussed herein can be applied to other types of documents and/or contracts.

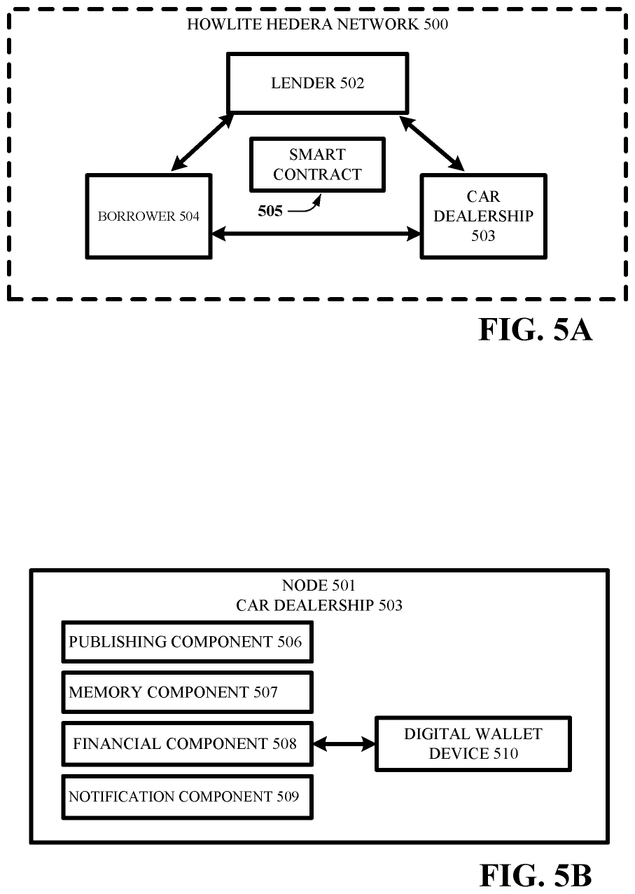

FIG. 5A illustrates a block diagram of an example, non-limiting use case of the distributed ledger network for publishing property liens in accordance with one or more embodiments described herein. FIG. 5B illustrates another block diagram of an example, non-limiting use case of the distributed ledger network for publishing property liens in accordance with one or more embodiments described herein. Repetitive description of like elements and/or processes employed in respective embodiments is omitted for sake of brevity.

In one or more embodiments, Howlite Hedera network 500 can be utilized to publish contracts associated with liens for properties including vehicles, airplanes, maritime vessels such as boats, homes, industrial equipment, etc. and for maintaining records on the properties. For example, borrower 504 can buy a car from car dealership 503. The car can be financed (e.g., through a loan) by lender 502 (e.g., a bank or other financing entity), and smart contract 505 can be published by lender 502 to establish a lien for the car on Howlite Hedera network 500 such that lender 502 can be a lienholder for the car. For example, smart contract 505 can be based on a 2-year financing period for the car such that borrower 504 can be required to make monthly payments of a predetermined amount to lender 502 to pay the loan, and the car can be repossessed by lender 502 if borrower 504 fails to make loan payments for over a predetermined amount of time. Thus, clauses of the lien can be built into smart contract 505. Lender 502, car dealership 503 and borrower 504 can each participate on Howlite Hedera network 500 via respective nodes, in accordance with one or more embodiments discussed herein. In another embodiment, car dealership 503 can act as the borrower and be responsible for paying the lender 502 for the car.

Node 501 illustrated in FIG. 5B can belong to lender 502 on Howlite Hedera network 500, and node 501 can comprise publishing component 506, memory component 507, financial component 508, notification component 509, and digital wallet device 510. As stated in one or more embodiments herein, publishing component 506 can assist with publishing the lease as smart contract 505 and memory component 507 can update and maintain a record of an updated Hedera distributed ledger on each node within Howlite Hedera network 500. Financial component 508 can enable HowlCard operations for end users such as borrower 504, car dealership 503 and/or lender 502 such that when coupled to digital wallet device 510, financial component 508 can enable timely payment transfers via a HowlCard wherein the HowlCard can be funded by HBAR with balance transfers from fiat money. Since HowlCards can be standalone or scale to other banks, Howlite Hedera network 500 can present a convenient, non-proprietary platform for both a lender and a borrower. Notification component 509 can be used to set alerts and notifications for car dealership 503 and borrower 504 for missed payments, repossessions, late payment penalties, and so on.

All individuals leasing or purchasing vehicles from car dealership 503 and financed by lender 502 can be part of Howlite Hedera network 500 and can communicate with one another using Hedera's gossip-about-gossip protocol. In case of repossessions due to late or missed payments, consensus can be reached in a transparent way such that all parties involved with a respective lien can have a record of the transactions on Howlite Hedera network 500 in connection with the respective lien, which can prevent fraud from the side of a lending institution (e.g., lender 502) as well as the borrower. Furthermore, car dealership 503 can maintain records on all vehicles leased and/or purchased through them wherein an immutable log of information about individuals purchasing and/or leasing the vehicles, the payment timeframe, miles accumulated, etc. can be maintained via HCS. The immutable log can be audited and used by the dealership to prove their credibility and attract customer loyalty.

In an aspect, another dealership financed by lender 502 can also be part of the network and individual smart contracts governing leasing and/or purchasing policies for other dealerships can be published within the network. As an example, American Honda Financial Corporation (AHFC) assists with the financing needs of several Honda and Accura customers for products including, automobiles, motorcycles, marine engines and even power equipment. Each type of vehicle or equipment can be offered by different dealerships and each dealership can have numerous customers. Management of such a vast network of people and contracts such as leases, liens, maintenance records and more can be easily governed via HCS and can be further assisted by a Howlite payments platform.

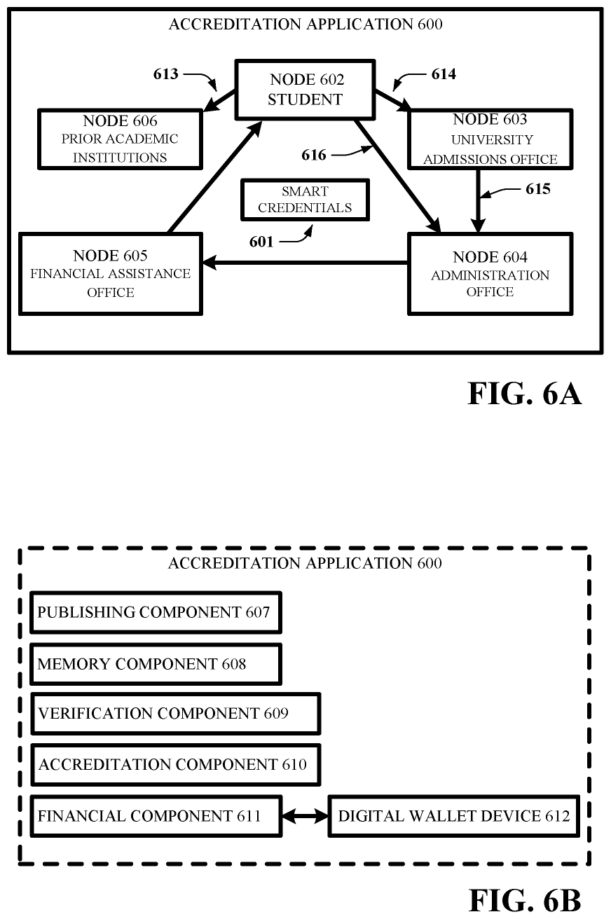

FIG. 6A illustrates a block diagram of an example, non-limiting use case of the distributed ledger network for academia in accordance with one or more embodiments described herein. FIG. 6B illustrates another block diagram of an example, non-limiting use case of the distributed ledger network for academia in accordance with one or more embodiments described herein. Repetitive description of like elements and/or processes employed in respective embodiments is omitted for sake of brevity.

In one or more embodiments, accreditation application 600 can comprise node 602, node 603, node 604, node 605 and node 606 respectively associated with a student, a university admissions office, an administration office, a financial assistance office, and prior academic institutions, as part of an academic setting. Accreditation application 600 can further comprise smart credentials 601. In an embodiment, accreditation application 600 can be an online app associated with a Howlite Hedera network for accreditation of documents such as diplomas, academic certificates, etc. For example, a student at node 602 can publish digital copies of their admissions documents and high school academic credentials as smart credentials 601 on a Howlite Hedera network, for securing an admission to a degree program at a university. Once the documents have been published, message 613 can be sent from node 602 on the Howlite Hedera network to the prior academic institute of the student (e.g., a high school) for approving the legitimacy and credibility of the documents, such that an approval from the prior academic institute can be made available via a common distributed ledger (e.g., Hedera distributed ledger) for all participating individuals and institutions to review.

The student can also send message 614 to node 603 notifying the university admissions office that the credentials are uploaded to the Hedera application. Upon receipt and/or approval of credentials, node 603 can initiate message 615 to the university's administration office at node 604 to follow up with the student regarding additional admissions procedures and requirements such as placement tests, student ID cards, and so on. A transaction for an initial fee payment for admission can also be initiated as message 616 from the student to the administration office upon confirmation that the student has secured a place at the university. In an embodiment, if the student is eligible for scholarships and financial assistance, the administration office can contact the financial assistance office at node 605, which can then contact the student notifying them of the necessary logistical steps involved in securing the scholarship.

With reference to FIG. 6B, accreditation application 600 can be downloaded by concerned parties and multiple students can be a part of the network. Each party can have access to relevant components of the application. For example, the student and the university admissions office can access the publishing component 607 for publishing credentials and diplomas. Memory component 608 can perform the task of updating and recording a common ledger (e.g., Hedera distributed ledger) each time that the common ledger is updated. For example, academic institutions, students and/or other individuals, admissions offices and financial assistance offices at a university can have access to verification component 609 and accreditation component 610 to ensure fraud prevention with admissions processes or in connection with new and/or existing students. In an aspect, verification component 609 can be used by universities to ensure that a student remains in good academic standing for scholarships based on minimum GPA. For example, when a consensus on a student's academic standing cannot be reached by all concerned parties, his or her scholarships can be revoked by the university. Accreditation component 610 can prevent fraud by requiring an impartial party, such as a prior academic institution (e.g., a high school) of a student seeking admission to a university, to verify legitimacy of the student's credentials. In an embodiment, accreditation applications such as accreditation application 600 can provide a standardized admissions format for students from outside a country seeking admission to an academic institute or another higher learning institute within the country. This can assist with streamlining and standardizing admission procedures for all parties involved since different foreign universities can have different grading systems.

Financial component 611 can be coupled with digital wallet device 612 to address the financial needs of academic institutions and the students. For example, for students eligible for a scholarship, a HowlCard can be issued by the university to students having a Hedera account or an existing credit/debit card can be enabled by a Howlite payments platform such that the students can use the HowlCard/Howlite payments platform enabled credit card for academic purchases. For example, a university can issue a HowlCard to a student as part of a scholarship such that HowlCard can be reloaded with a predetermined HBAR amount at the beginning of every semester at the university. The HowlCard can be used by the student to purchase books and stationery, etc. An admissions application such as accreditation application 600 can have huge potential to prevent admissions scams and frauds. The Hedera consensus can allow for convenient management of a vast network of students and university staff involved in admissions, since Hedera has very high throughput capabilities and consensus can be reached quickly and transparently.

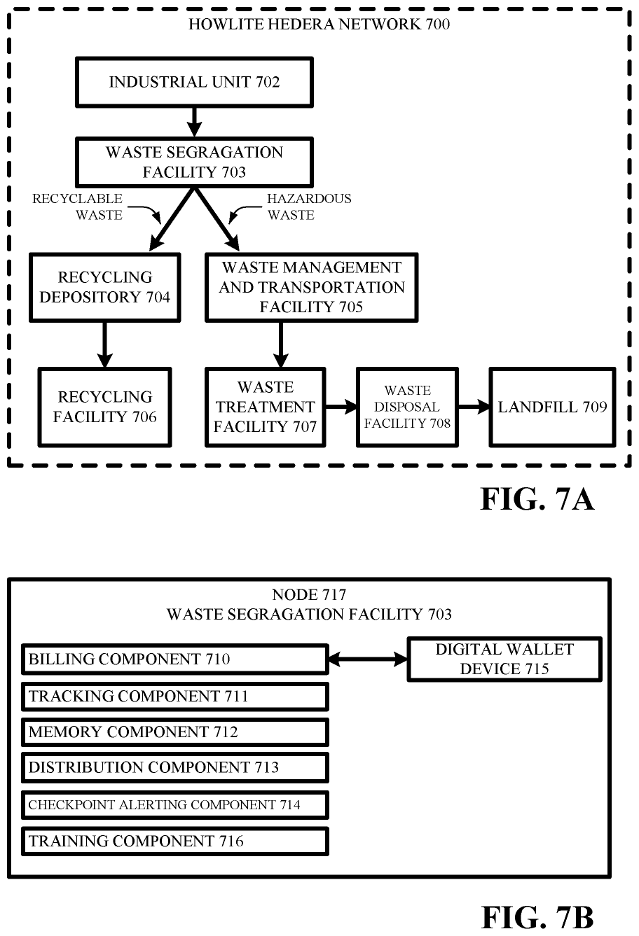

FIG. 7A illustrates a block diagram of an example, non-limiting use case of the distributed ledger network for hazardous waste material disposal and tracking in accordance with one or more embodiments described herein. FIG. 7B illustrates another block diagram of an example, non-limiting use case of the distributed ledger network for hazardous waste material disposal and tracking in accordance with one or more embodiments described herein. Repetitive description of like elements and/or processes employed in respective embodiments is omitted for sake of brevity.

In one or more embodiments, Howlite Hedera network 700 can comprise industrial unit 702, waste segregation facility 703, recycling depository 704, waste management and transportation facility 705, recycling facility 706, waste treatment facility 707, waste disposal facility 708, and landfill 709. Howlite Hedera network 700 can be used to track the transportation and disposal of HW produced at an industrial unit. Consider the waste management ecosystem illustrated in FIG. 7A wherein HW can be transported from industrial unit 702 to waste segregation facility 703 that can accept waste from one or more neighboring industrial facilities, and wherein waste products can be sorted into recyclable waste and non-recyclable, hazardous waste. The recyclable waste can be sent to recycling depository 704 from where it can be sent for recycling to recycling facility 706. The HW can be sent to the waste management and transportation facility 705, wherein waste management and transportation facility 705 can be responsible for the proper transportation and handling of non-recyclable waste. From waste management and transportation facility 705, the waste can be transported to waste treatment facility 707 where it can be treated to make it safe for disposal by waste disposal facility 708. Finally, waste disposal facility 708 can dispose the HW into a landfill 709.

Since each entity involved in the exemplary waste management ecosystem discussed herein can be responsible to comply with the relevant waste management, transportation and disposal regulations, each entity can assume a node on Howlite Hedera network 700. For instance, node 717 illustrated in FIG. 7B can represent waste segregation facility 703 within Howlite Hedera network 700. Node 717 can comprise checkpoint alerting component 714 which can allow waste segregation facility 703 to set up checkpoints for the various entities involved in waste management such that a transaction can be initiated within Howlite Hedera network 700 when waste is received from or transported to a facility within the waste management ecosystem. Checkpoint alerting component 714 can work alongside tracking component 711 to ensure that HW is correctly handled while being transported, track accidents, and ensure that delays due to unnecessary detours by bad actors are minimized and/or eliminated. For instance, if waste treatment facility 707 is due to receive a shipment of HW originating at industrial unit 702, from waste management and transportation facility 705, by 3:00 μm on a given Tuesday, waste treatment facility 707 can generate a message on Howlite Hedera network 700 once the shipment is received. Since every node on Howlite Hedera network 700 for all participating entities can be notified of the message, they can reach consensus on the shipment, and if the message is sent prematurely in anticipation of the shipment of hazardous waste, then a consensus can be delayed until all parties agree.

Distribution component 713 can assist with the segregation of recyclable and non-recyclable waste and further assist in ensuring that each type of waste is distributed to the correct facility. Memory component 712 can update and record the Hedera distributed ledger for Howlite Hedera network 700, and it can function in conjunction with HCS to preserve a log of waste management and disposal activities for every waste producing unit that can have a contract with waste segregation facility 703. Further, Hedera's data compliance feature can allow for the preserved log to be publicly verifiable. Billing component 710 can assist with the financial transactions involved with the waste management lifecycle, and it can function alongside digital wallet device 715 to receive, store and/or transfer cryptocurrency from and to other facilities. Additionally, data contained in forms and other tracking events can be made available to appropriate entities. This can provide data monetization and increases the usage of the ecosystem.

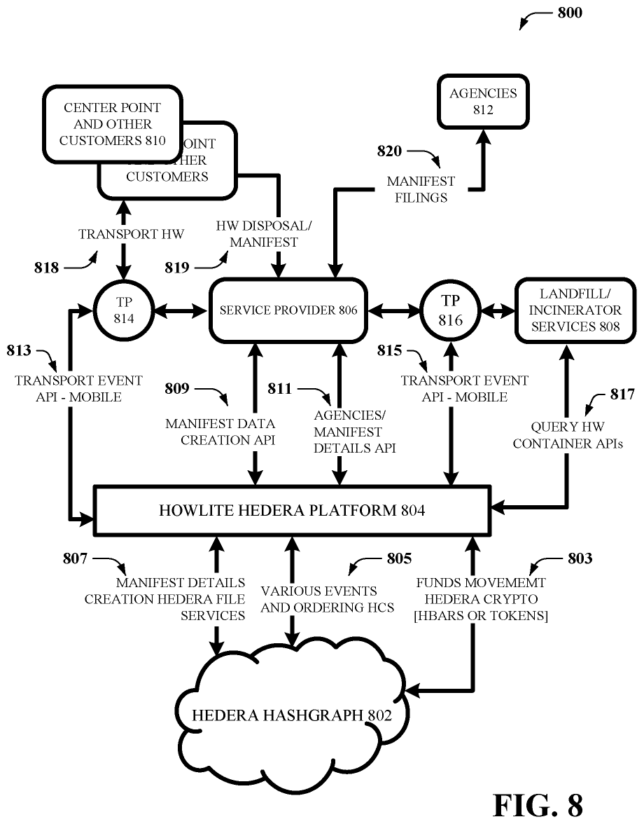

In one or more embodiments, a smart contract governing proper waste management compliance training through Howlite Hedera network 700, can be deployed by training component 716 of node 717 for training employees. As discussed earlier in this application, the smart contract can have steps that need to be completed before a training is considered complete and a consensus on the training score can reached via virtual voting. Other nodes within Howlite Hedera network 700 can comprise some or all the components and devices discussed herein. This can allow each facility to transparently track the flow of waste from every source down to the transportation route and disposal of the type of waste. Waste producing units and management facilities can ensure compliance, and errors or mishaps in handling waste can be promptly dealt with. A further embodiment of waste tracking and disposal using Hedera Hashgraph enabled Howlite payments platform is discussed with reference to FIG. 8.

FIG. 8 illustrates a block diagram 800 of an example, non-limiting use case of the distributed ledger network for HW material disposal, tracking and monetization in accordance with one or more embodiments described herein. Repetitive description of like elements and/or processes employed in respective embodiments is omitted for sake of brevity.

In one or more embodiments, Howlite Hedera platform 804 can enable HW tracking from an origin of the HW along with appropriate regulatory compliance activities, and disposal tracking all the way to a final destination leveraging Howlite Hedera platform 804 for orchestration with Hedera Hashgraph as an underlying DLT & blockchain. CenterPoint and other customers 810 can represent one or more customer entities engaged in generating the HW. Service provider 806 can be an entity (e.g., TAS Environmental) that can provide compliant HW disposal service to CenterPoint and other customers 810. Agencies 812 can comprise the EPA and/or other agencies associated with HW tracking and handling regulations.

Landfill/Incinerator services 808 can represent entities (e.g., a landfill/incinerator facility (LIF)) that can dispose the HW based on the type of HW presented. In an embodiment, an LIF can also act as a buyer of data (e.g., tracking data, etc.) produced by Howlite Hedera platform 804. Howlite Hedera platform 804 can provide a HW disposal and tracking platform (Howlite HW platform) to the above entities (e.g., service provider 806, agencies 812, landfill/incinerator services 808, etc.) via APIs, and Howlite Hedera platform 804 can manage orchestration layers among the various entities and Hedera Hashgraph DLT & blockchain (e.g., Hedera Hashgraph 802). Transport point (TP) 814 and TP 816 can represent flow of HW along with event tracking to Hedera Hashgraph 802 using appropriate location-based tracking and APIs.

In one or more embodiments, CenterPoint and other customers 810 can engage service provider 806 to dispose HW, and at 819, service provider 806 can receive an HW manifest from CenterPoint and other customers 810. At 807, Hedera file services can be utilized for manifest details creation. Service provider 806 can utilize APIs from Howlite Hedera platform 804 to store details of the HW manifest with the Howlite HW platform, wherein the Howlite HW platform can generate the appropriate data within the blockchain. For example, at 809 and 811, service provider 806 can respectively utilize a manifest data creation API and an EPA/manifest details API from Howlite Hedera platform 804. At 820, agencies 812 can receive manifest filings from service provider 806.

Further, service provider 806 can orchestrate pickup of HW from CenterPoint and other customers 810 with suitable transporters and transports can be provided with a mobile API. For example, at 818, HW transport can be facilitated via TP 814. For example, at 813 and 815, transports can be provided with mobile APIs. If tracking systems are utilized, the API can be provided to mobile tracking systems to leverage and feed an HW transportation event from an HW generator to the landfill/incinerator services 808. Landfill/incinerator services 808 or their systems integration can be provided query and retrieval APIs to acquire details on the HW manifest to identify and validate the HW. For example, at 817, landfill/incinerator services 808 can receive query HW container APIs. If there are multiple handoffs and way points for transporting HW, all events can be available for querying. At 805, various events can be ordered using HCS.

From a monetization perspective, landfill/incinerator services 808 can pay fees for querying information from the Howlite HW platform and leveraging the crypto APIs available in Hedera Hashgraph 802. Funds can be distributed cost effectively and in real-time to all appropriate entities in the HW waste tracking and disposal eco-system discussed herein. Entities can be paid for leveraging the Howlite HP platform and providing data, and a HowlCard with tokens (e.g., Hedera tokens) or HBAR can be used to setup multi-party payments in accordance with one or more embodiments herein (e.g., at 803).

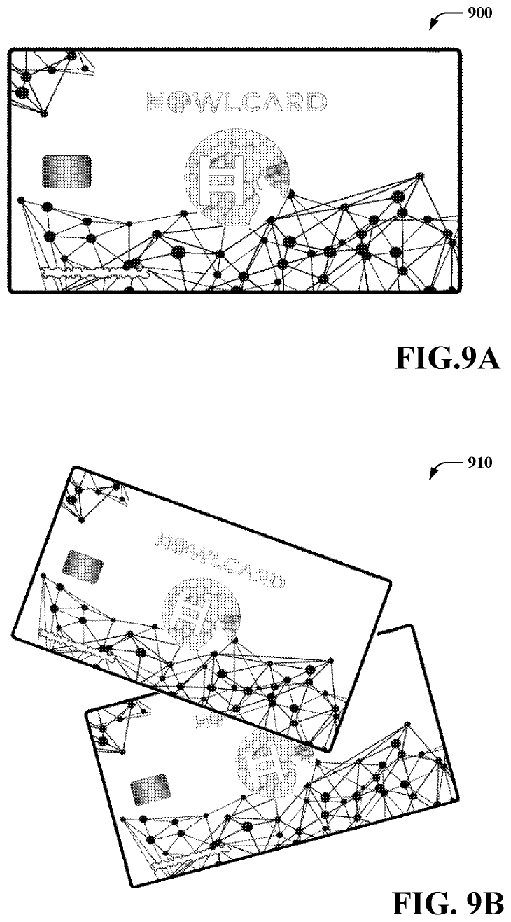

FIG. 9A illustrates an example, non-limiting view 900 of a HowlCard in accordance with one or more embodiments described herein. FIG. 9B further illustrates an example, non-limiting view 910 of HowlCards in accordance with one or more embodiments described herein. Repetitive description of like elements and/or processes employed in respective embodiments is omitted for sake of brevity.

In one or more embodiments, a HowlCard can be issued to a Hedera account holder. The HowlCard can be a payment device similar to a credit card or a debit card with a chip, and the HowlCard can be funded by HBAR with balance transfer from fiat. A Howlite payments platform that can enable the HowlCard can operate similar to an interbank network (e.g., Star, Pulse, Visa, Mastercard, etc.) by recognizing a prefix of a card number as a Howlite enabled payment instrument. It is to be appreciated that the illustrations shown in FIGS. 9A and 9B are for exemplary purposes.

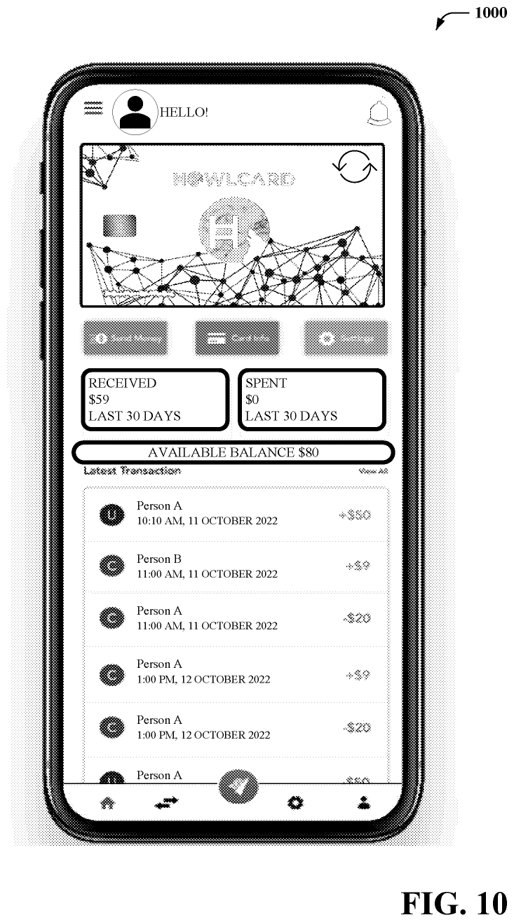

FIG. 10 illustrates an example, non-limiting view 1000 of an embodiment of a Howlite application in accordance with one or more embodiments described herein. Repetitive description of like elements and/or processes employed in respective embodiments is omitted for sake of brevity.

As discussed in one or more embodiments, a Howlite Hedera platform can provide benefits of web3/DLT to traditional payments by bridging infrastructure to realize the benefits of DLT using commonly understood and used payment tools (e.g., payment cards, bank accounts, etc.) by end users (e.g., businesses, consumers, merchants, etc.). Funds flow can leverage native Hedera Hashgraph functions which can allow payments to be cost-effective due to a transaction fee structure and fixed to US dollars (USD) via HTS. Further, payments can be secure, transparent, and easy. The benefits of such a payments eco-system offered by the Howlite Hedera platform can be further enhanced by a HowlCard (e.g., FIGS. 9A and 9B). The HowlCard can enable a flexible acceptance methodology with minimal business operations (BizOps) changes seamless to users, and users can use the HowlCard like a credit card or debit card in conjunction with a mobile-based application, as illustrated in non-limiting view 1000.

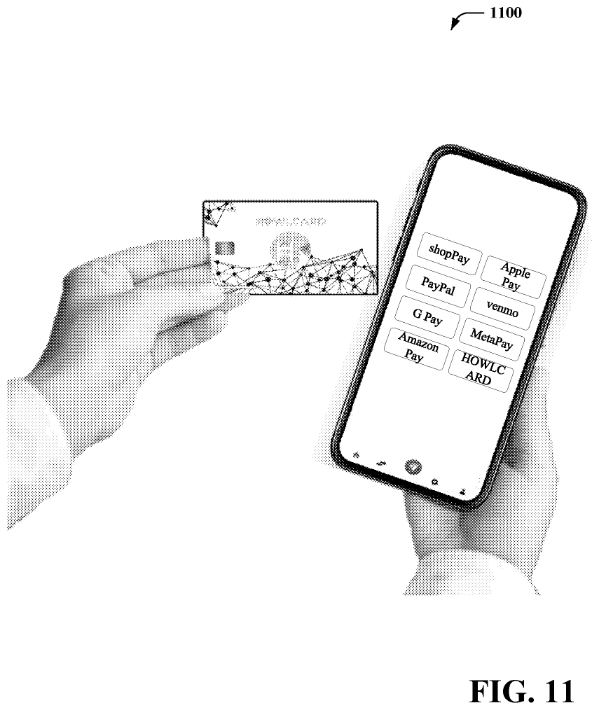

FIG. 11 illustrates an example, non-limiting view 1100 of an embodiment of the HowlCard and the Howlite application in accordance with one or more embodiments described herein. Repetitive description of like elements and/or processes employed in respective embodiments is omitted for sake of brevity.

As discussed in FIG. 10, users can use the HowlCard like a credit card or a debit card or on a Howlite application (e.g., similar to Venmo, Amazon Pay, etc.), as illustrated in non-limiting view 1100. HowlCard can provide a seamless global payment system and facilitate payments without borders. HowlCard can also assist with traversing international bank-to-bank payment limitations and high-level issues where existing systems can be expensive, take a long time to settle, and be tedious with information verification (for both sender and recipient).

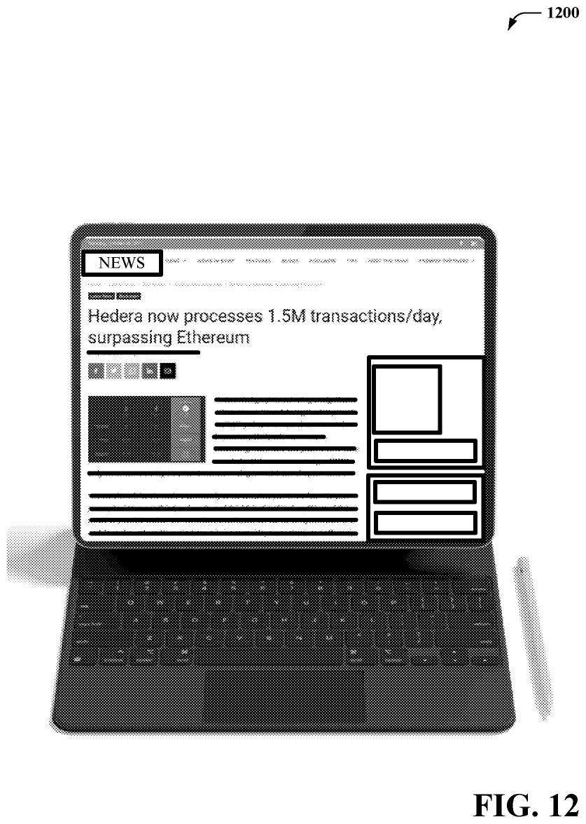

FIG. 12 illustrates an example, non-limiting embodiment 1200 of the distributed ledger network discussed herein in accordance with one or more embodiments described herein. Repetitive description of like elements and/or processes employed in respective embodiments is omitted for sake of brevity.

Hedera Hashgraph is a DLT that can scale to transaction processing and throughput needed to support a HowlCard (e.g., FIGS. 9A and 9B) use case, while meeting regulatory requirements. A Howlite payments platform based on Hedera Hashgraph can enable transaction fee reductions. Table 1 displays some exemplary values for the speed benefits offered by Hedera Hashgraph as compared to Bitcoin and Ethereum. It is to be appreciated that some of the values listed in table 2 may be time specific.

TABLE 1

| | 1^{st} generation | | 2^{nd} generation | | 3^{rd} generation | |
|---|---|---|---|---|---|---|
| | Bitcoin (BTH) | | Ethereum (ETH) | | Hedera (HBAR) | |
| Transactions | 3+ | TPS | 12+ | TPS | 10,000+ | TPS |
| per second | | | | | | |
| Average fee | $0.20 | USD | $0.13 | USD | $0.0001 | USD |

| | | | | | |
|---|---|---|---|---|---|
| Transaction | 10-60 | minutes | 10-20 | seconds | 3-5 seconds |
| confirmation | | | | | (with finality) |

In one or more embodiments, the Howlite payments platform can enable multiple transactions, for example, person-to-person transactions, business-to-consumer (B2B) transactions, multiparty B2B transactions, etc. can be cost effectively enabled due to fixed transaction fees on the Howlite payments platform. The Howlite payments platform can also be cost-effective on the currency conversion side. HowlCard can be a payment system built on DLT that can scale to transaction processing and throughput needed to support these use cases with regulatory compliance, security, and token-price volatility in mind. Howlcard can be one financial instrument. Other financial institutions cards can run on a Howlite payments infrastructure (e.g., Howlite payments platform).

HowlCard can be a payment acceptance mark, or it can be a transparent routing mechanism for other payment acceptance marks such as Visa, MasterCard, etc. For example, Howlite can enable account-based payments to work through Hedera Hashgraph, and the payment cards associated with the account-based payments (e.g., Visa, MasterCard, etc.) can continue to work per their existing functionalities. Thus, Howlite can provide financial institutions the ability to take an existing financial card and route it through the Howlite payments platform. In an embodiment, the Howlite payments platform can perform real-time settlement of funds. For example, a financial institution can be instructed to perform real-time settlement of funds with or without moving the actual funds. For example, a bank can be instructed to move money from one account to another such that the funds are not physically moved between accounts. For example, a bank can be instructed to move money from one account to another such that the funds are physically moved between accounts and are not held in the account that it is moved from.

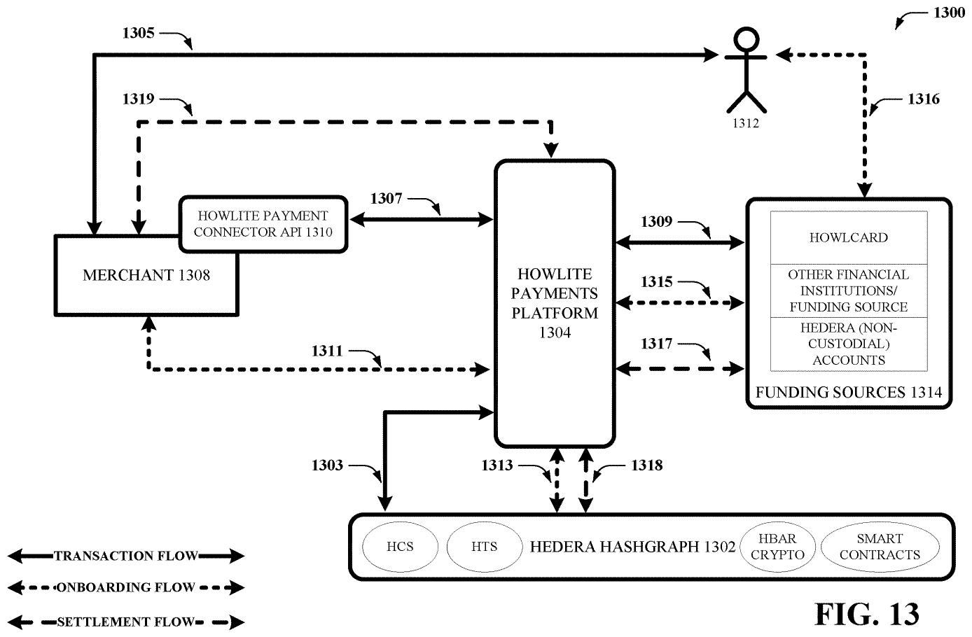

FIG. 13 illustrates an example, non-limiting flow diagram 1300 of interactions based on a Howlite payments platform ecosystem in accordance with one or more embodiments described herein. Repetitive description of like elements and/or processes employed in respective embodiments is omitted for sake of brevity.

While web3 can offer significant advantages as compared to web2, usage has been limited to certain verticals and certain subsets of end users that are tech savvy due to complex end user experiences with the setup, interaction of crypto accounts, DLT, account keys, password recovery phrases, etc. Howlite (e.g., Howlite Hedera network, Howlite platform, Howlite payments platform, etc.) can provide all the benefits of DLT while allowing for end users to use and merchants to accept transactions as they can be accustomed to doing with traditional payment instruments (e.g., VISA, Mastercard, credit/debit cards, bank accounts, etc.). Howlite bridges web3 with traditional payment rails. End users and payment acceptors (e.g., merchants) can leverage the Howlite platform running on Hedera Hashgraph with no awareness on DLT running behind the scenes. The DLT/blockchain aspect of Howlite can be exposed as required to increase usage, and awareness.

In one or more embodiments, Howlite payments platform 1304 can interact with Hedera Hashgraph 1302 at 1303 to enable HTS transfers from consumer accounts to merchants and HCS transaction postings comprising merchant view, regulatory view and funding source as part of a transaction pipeline. It is to be appreciated that the arrows with different line types in FIG. 13 illustrate different types of flows in accordance with a legend displayed at the bottom left of FIG. 13. At 1307, Howlite payments platform 1304 can interact with Howlite payment connector API 1310 associated with merchant 1308 to enable processing payments and provide results and insights in connection with the payments interactions. At 1305, Howlite payments platform 1304 can facilitate generating a funding card (e.g., HowlCard) for end users such as consumer 1312 to use at checkout while making a purchase with merchant 1308 and to use a funding source mobile app. Further, at 1309, Howlite payments platform 1304 can enable a sync balance with Howlite tokens and transaction postings. Howlite tokens can represent a unit of value or a form of value for financial transactions. Howlite tokens can move between accounts. Howlite tokens do not represent actual currency moving between bank accounts.

In one or more embodiments, Howlite payments platform 1304 can interact with Hedera Hashgraph 1302, at 1313, to enable new Hedera account creations, provisioning existing Hedera account holders with Howlite capabilities, and enabling Howlite tokens as part of an onboarding pipeline. At 1311, Howlite payments platform 1304 can interact with merchant 1308 to enable new Hedera account creations, provisioning existing Hedera account holders with Howlite capabilities, and enabling Howlite tokens and Know Your Customer (KYC) standards. At 1316, Howlite payments platform 1304 can assist end users such as consumer 1312 with creating a new Howlite enabled account that can work with a Howlite enabled account mobile app (e.g., Howlite app). Further, as part of the onboarding pipeline, Howlite payments platform 1304 can assist funding sources 1314, at 1315, with creating a new Howlite enabled account and enable a sync balance with Howlite tokens, wherein funding sources 1314 can represent a HowlCard, financial institutions, other funding sources, and Hedera non-custodial accounts.

In one or more embodiments, Howlite payments platform 1304 can interact with Hedera Hashgraph 1302, at 1318, to enable Howlite tokens adjustments as part of a settlement pipeline. At 1319, Howlite payments platform 1304 can interact with merchant 1308 to enable settlement of funds from Howlite tokens to fiat money. Similarly, at 1317, Howlite payments platform 1304 can assist funding sources 1314 with settlement of funds from Howlite tokens to fiat money as part of the settlement pipeline.

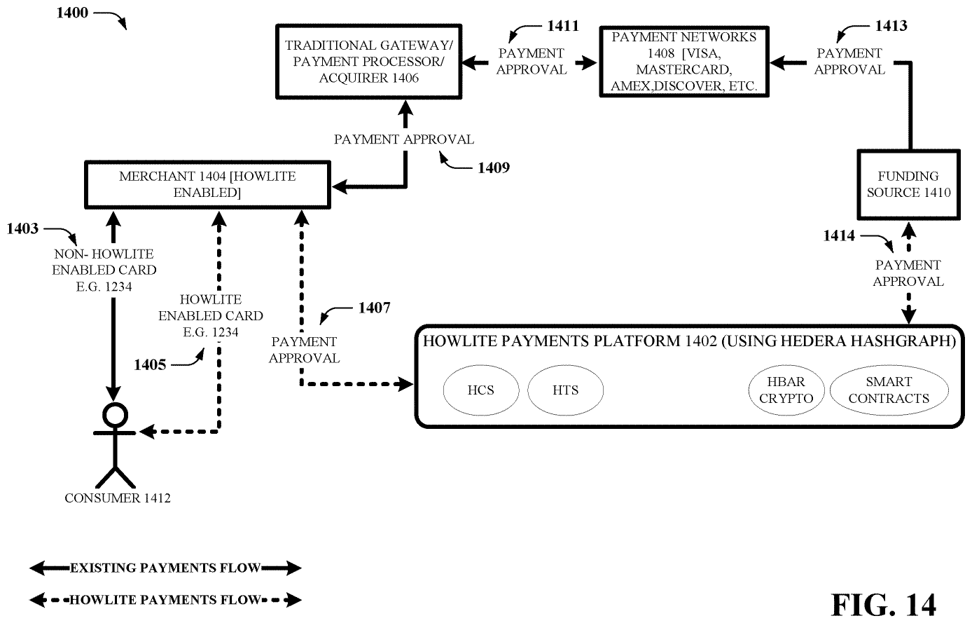

FIG. 14 illustrates an example, non-limiting flow diagram 1400 of interactions based on a Howlite payments platform ecosystem in accordance with one or more embodiments described herein. Repetitive description of like elements and/or processes employed in respective embodiments is omitted for sake of brevity.

FIG. 14 illustrates transparent routing of existing payment acceptance methods (illustrated by the solid lined arrows) over a Howlite payments infrastructure (illustrated by the dashed arrows). In one or more embodiments, Howlite payments platform 1402 (using Hedera Hashgraph) can assist various entities (e.g., consumers, merchants, funding sources, etc.) to acquire fast payment approval associated with one or more transactions. For example, with existing payment rails, customer 1412 can use a non-Howlite enabled card (e.g., existing payment cards) at 1403 to engage in a financial transaction with merchant 1404. Without Howlite enablement, the financial transaction can be required to go through traditional gateway/payment processor/acquirer 1406, payment networks 1408 and funding source 1410 with payment approvals required at 1409, 1411 and 1413. If the non-Howlite enabled card used by customer 1412 at 1403 and merchant 1404 can be Howlite enabled, the payments eco-system can be shortened (illustrated by dashed arrows) and can require the involvement of lesser entities. For example, customer 1412 can use a Howlite enabled card (e.g., existing payment cards that are Howlite enabled) at 1405 to engage in a financial transaction with merchant 1404 (Howlite enabled) such that Howlite payments platform 1402 can enable payment approvals at 1404 and 1414.

The Howlite enabled card can provide benefits of strong security through device biometrics, private key for Hedera accounts, etc. Further, Howlite enabled merchant accounts (e.g., merchant 1404) can benefit from zero-integration at checkout, lower payment acceptance cost, security (transactions can be protected by biometrics and private key), enhanced data signals, alternative routing mechanisms (e.g., as opposed to traditional rails), and enable regulatory and compliance friendly operations. Similarly, the Howlite payments platform 1402 can benefit funding source 1410 via Howlite enabled cards that can increase transaction usage for the issue, security (transactions can be protected by biometrics and private key), enable regulatory and compliance friendly operations, better fees compared to some traditional debit cards, and enhanced data signals.

In one or more embodiments, Howlite payments platform 1402 can provide several merchant facing benefits. For example, Howlite payments platform 1402 can provide frictionless and seamless acceptance of Howlite enabled cards, wherein an online merchant's checkout process can detect and route Howlite enabled cards using Howlite payments platform 1402 or using a traditional platform. For example, cost of payment acceptance using Howlite payments platform 1402 can be significantly less than traditional payment acceptance costs. In addition to the raw payment processing costs, other costs associated with fraud, payment declines, etc. can also be significantly reduced when the payment instrument is processed using Howlite (e.g., Howlite payments platform 1402). For example, since payments processed using Howlite (e.g., Howlite payments platform 1402) have to be secured and digitally signed by the end user, the payments can be protected by private keys in a device (e.g., typically a mobile device and/or another type of device) in the end user's possession via biometrics on a device.

For example, since Howlite transactions can be processed by utilizing traditional payment workflows, there are minimal to no changes to processes and underlying workflow management across different subsystems within a merchant's business. For example, payment processing can often be interrelated to Inventory Systems, Financial Systems, Supplychain and order managements. The unique design of Howlite processing can allow merchants to retain and maintain their business operations without any changes. For example, depending on a specific use case, multi-buyer and multi-seller use cases can be made available for the specific use case (e.g., Marketplace Operator, OTAs, etc.). For example, using Howlite's underlying DLT on Hedera Hashgraph, transactions processed via Howlite can leverage HCS that can allow for transparency and regulatory compliance.

For example, regional financial regulations such as Payment Services Directive Two (PSD2) in Europe, General Data Protection Regulation (GDPR), California Consumer Privacy Act (CCPA), Federal Reserve Board (Fed) amendments to Regulation II under Durbin Amendment, etc. can be enabled on a voluntary basis with the appropriate agencies. Data Localization requirements can also be met with permissioned Hedera node structures where selective routing based on data localization regulations can be enabled. For example, a Howlite platform (e.g., Howlite payments platform 1402) can provide merchants with rich data insights related to the transactions they process since all Howlite transactions have digital points of interaction.

In one or more embodiments, Howlite payments platform 1402 can provide several consumer facing benefits. For example, consumers can use an existing funding source that can be Howlite enabled to make payment. Usage can be driven by familiar experiences already offered by a consumer's financial institution. For example, transactions utilizing the Howlite platform can be signed by a consumer using native device capabilities that the consumer is already familiar with. Without this digital signature, their accounts can be used on the Howlite platform, thereby greatly increasing security, and reducing possibilities of fraud.

For example, support for person-to-person (P2P) payments can be instantly available without geographical boundary restrictions. For example, payments can be shared/split between multiple end users based on a use case. For example, Howlite enabled accounts can earn rewards using underlying Hedera staking mechanisms. For example, Howlite enabled end users can receive payments on their respective Howlite enabled accounts.

In one or more embodiments, Howlite payments platform 1402 can provide several issuer facing benefits. For example, with Howlite's lower cost of processing, merchants can highlight Howlite platform enablement that can ultimately increase usage of the issuer's financial instrument and increase adoption of the issuer's payments. For example, using Howlite's underlying DLT on Hedera, transactions processed via Howlite can leverage HCS that can allow for transparency and regulatory compliance. Regional financial regulations such as PSD2 in Europe, GDPR, CCPA, Fed amendments to Regulation II under Durbin Amendment, etc. can be enabled on a voluntary basis with the appropriate agencies. Data Localization requirements can also be met with permissioned Hedera node structures, wherein selective routing based on data localization regulations can be enabled. For example, compared to certain payment instruments, Howlite enabled payments can provide issuers with additional revenue for Howlite enablement as compared to a channel's native enablement.

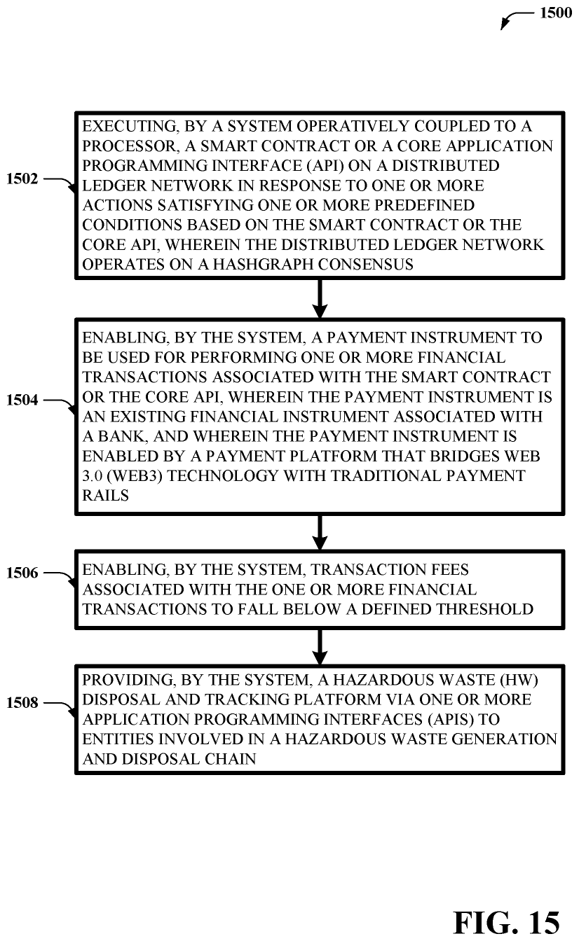

FIG. 15 illustrates a flow diagram of an example, non-limiting method 1500 in accordance with one or more embodiments described herein. Repetitive description of like elements and/or processes employed in respective embodiments is omitted for sake of brevity.

At 1502, the non-limiting method 1500 can comprise executing (e.g., by execution component 118), by a system operatively coupled to a processor, a smart contract or a core API on a distributed ledger network in response to one or more actions satisfying one or more predefined conditions based on the smart contract or the core API, wherein the distributed ledger network operates on a hashgraph consensus.

At 1504, the non-limiting method 1500 can comprise enabling (e.g., by payment component 120), by the system, a payment instrument to be used for performing one or more financial transactions associated with the smart contract or the core API, wherein the payment instrument is an existing financial instrument associated with a bank, and wherein the payment instrument is enabled by a payment platform that bridges web3 technology with traditional payment rails.

At 1506, the non-limiting method 1500 can comprise enabling (e.g., by payment component 120), by the system, transaction fees associated with the one or more financial transactions to fall below a defined threshold.

At 1508, the non-limiting method 1500 can comprise providing (e.g., by tracking component 711), by the system, an HW disposal and tracking platform via one or more APIs to entities involved in a hazardous waste generation and disposal chain.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively perform and track largescale transactions over blockchain or DLT as the one or more embodiments described herein can enable this process. And, neither can the human mind nor a human with pen and paper perform largescale transactions over blockchain or DLT, as conducted by one or more embodiments described herein.

In order to provide additional context for various embodiments described herein, FIG. 16 and the following discussion are intended to provide a brief, general description of a suitable computing environment 1600 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 16, the example environment 1600 for implementing various embodiments of the aspects described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and an optical disk drive 1620 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid-state drive (SSD) could be used in addition to, or in place of, an HDD 1614. The HDD 1614, external storage device(s) 1616 and optical disk drive 1620 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1694 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enable with a security module, such as a trusted processing module (TPM). For instance, with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can be also connected to the system bus 1908 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the Internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are example and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Referring now to FIG. 17, there is illustrated a schematic block diagram of a computing environment 1700 in accordance with this specification. The system 1700 includes one or more client(s) 1702, (e.g., computers, smart phones, tablets, cameras, PDA's). The client(s) 1702 can be hardware and/or software (e.g., threads, processes, computing devices). The client(s) 1702 can house cookie(s) and/or associated contextual information by employing the specification, for example.

The system 1700 also includes one or more server(s) 1704. The server(s) 1704 can also be hardware or hardware in combination with software (e.g., threads, processes, computing devices). The servers 1704 can house threads to perform transformations of media items by employing aspects of this disclosure, for example. One possible communication between a client 1702 and a server 1704 can be in the form of a data packet adapted to be transmitted between two or more computer processes wherein data packets may include coded analyzed headspaces and/or input. The data packet can include a cookie and/or associated contextual information, for example. The system 1700 includes a communication framework 1706 (e.g., a global communication network such as the Internet) that can be employed to facilitate communications between the client(s) 1702 and the server(s) 1704.

Communications can be facilitated via a wired (including optical fiber) and/or wireless technology. The client(s) 1702 are operatively connected to one or more client data store(s) 1708 that can be employed to store information local to the client(s) 1702 (e.g., cookie(s) and/or associated contextual information). Similarly, the server(s) 1704 are operatively connected to one or more server data store(s) 1710 that can be employed to store information local to the servers 1704.

In one exemplary implementation, a client 1702 can transfer an encoded file, (e.g., encoded media item), to server 1704. Server 1704 can store the file, decode the file, or transmit the file to another client 1702. It is noted that a client 1702 can also transfer uncompressed file to a server 1704 and server 1704 can compress the file and/or transform the file in accordance with this disclosure. Likewise, server 1704 can encode information and transmit the information via communication framework 1706 to one or more clients 1702.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A computer-implemented system, comprising:
a memory that stores computer-executable components; and
a processor that executes the computer-executable components stored in the memory, wherein the computer-executable components comprise:
an execution component configured to execute a smart contract on a Hedera distributed ledger network in response to one or more actions satisfying one or more predefined conditions defined by the smart contract, wherein the Hedera distributed ledger network operates on a hashgraph consensus;
an artificial intelligence (AI) component configured to:
train a model based on prior historical data to identify and authenticate users and to execute or deny financial transactions;
determine, using the model, a confidence level associated with a financial transaction associated with the smart contract;
determine, based on a value of the financial transaction, a confidence requirement applicable to the financial transaction, wherein a first confidence requirement applicable to a first financial transaction having a first value is greater than a second confidence requirement applicable to a second financial transaction having a second value lower than the first value; and
authorize execution of, or deny, the financial transaction based on whether the confidence level associated with the financial transaction satisfies the confidence requirement applicable to the financial transaction; and
a payment component configured to provide a payment platform that enables an existing financial instrument associated with a financial institution to be used for performing the financial transaction associated with the smart contract,
wherein the payment platform employs Hedera Token Service (HTS) to enable payment of the financial transaction via one or more native tokens, and
wherein the payment platform employs Hedera Consensus Service (HCS) to preserve an immutable log of messages associated with the financial transaction, the immutable log having fair consensus and a trusted timestamp.

2. The computer-implemented system of claim 1, wherein the AI component is configured to build and continuously train the model.

3. The computer-implemented system of claim 1, wherein the AI component is configured to monitor events or conditions and take automated action at one or more desired confidence levels.

4. The computer-implemented system of claim 1, wherein the AI component comprises a classifier configured to:
map an input attribute vector associated with the financial transaction to a confidence class; and
determine an action to be automatically performed based on the confidence class.

5. The computer-implemented system of claim 4, wherein the classifier employs at least one classification scheme or model selected from a support vector machine, a neural network, an expert system, a Bayesian belief network, fuzzy logic, a data fusion engine, naïve Bayes, a Bayesian network, a decision tree, a fuzzy logic model, or a probabilistic classification model.

6. The computer-implemented system of claim 1, wherein the existing financial instrument comprises at least one of a credit card, a debit card, a checking account, or a savings account associated with the financial institution.

7. The computer-implemented system of claim 1, wherein the payment platform enables funds associated with the financial transaction to be settled in real time such that at least one entity moves fiat money from a first financial account to a second financial account based on instructions to settle the funds.

8. The computer-implemented system of claim 1, wherein the existing financial instrument is funded via at least one of HBAR, a Hedera token, or fiat money.

9. The computer-implemented system of claim 1, wherein the payment platform allows a consumer to authorize the financial transaction using native device capabilities and one or more cryptographic keys, wherein the native device capabilities comprise at least one of Face ID, Touch ID, or Fast ID Online (FIDO) authentication, and wherein the one or more cryptographic keys comprise at least one of a public key or a private key.

10. The computer-implemented system of claim 1, wherein HTS is used natively to enable a payment token for a HowlCard, and wherein a stablecoin pegged to United States dollars is implemented using HTS.

11. The computer-implemented system of claim 1, wherein the execution component is further configured to execute, alternatively or in addition to the smart contract, a core Application Programming Interface (API) on the Hedera distributed ledger network in response to one or more actions satisfying one or more predefined conditions defined by the core API.

12. A computer-implemented method, comprising:
executing, by a system operatively coupled to a processor, a smart contract on a Hedera distributed ledger network in response to one or more actions satisfying one or more predefined conditions defined by the smart contract, wherein the Hedera distributed ledger network operates on a hashgraph consensus;
training, by the system, an artificial intelligence (AI) model based on prior historical data to identify and authenticate users and to execute or deny financial transactions;
determining, by the system using the AI model, a confidence level associated with a financial transaction associated with the smart contract;
determining, by the system based on a value of the financial transaction, a confidence requirement applicable to the financial transaction, wherein a first confidence requirement applicable to a first financial transaction having a first value is greater than a second confidence requirement applicable to a second financial transaction having a second value lower than the first value;
authorizing execution of, or denying, by the system, the financial transaction based on whether the confidence level associated with the financial transaction satisfies the confidence requirement applicable to the financial transaction;
enabling, by the system via a payment platform, an existing financial instrument associated with a financial institution to be used for performing the financial transaction associated with the smart contract;
employing, by the payment platform, Hedera Token Service (HTS) to enable payment of the financial transaction via one or more native tokens; and
employing, by the payment platform, Hedera Consensus Service (HCS) to preserve an immutable log of messages associated with the financial transaction, the immutable log having fair consensus and a trusted timestamp.

13. The computer-implemented method of claim 12, further comprising building and continuously training, by the system, the AI model.

14. The computer-implemented method of claim 12, further comprising monitoring, by the AI model, events or conditions and taking automated action at one or more desired confidence levels.

15. The computer-implemented method of claim 12, further comprising mapping, by a classifier, an input attribute vector associated with the financial transaction to a confidence class and determining an action to be automatically performed based on the confidence class, wherein the classifier employs at least one classification scheme or model selected from a support vector machine, a neural network, an expert system, a Bayesian belief network, fuzzy logic, a data fusion engine, naïve Bayes, a Bayesian network, a decision tree, a fuzzy logic model, or a probabilistic classification model.

16. The computer-implemented method of claim 12, further comprising settling funds associated with the financial transaction in real time such that at least one entity moves fiat money from a first financial account to a second financial account based on instructions to settle the funds, and funding the existing financial instrument via at least one of HBAR, a Hedera token, or fiat money.

17. The computer-implemented method of claim 12, further comprising allowing a consumer to authorize the financial transaction using native device capabilities and one or more cryptographic keys, wherein the native device capabilities comprise at least one of Face ID, Touch ID, or Fast ID Online (FIDO) authentication, and wherein the one or more cryptographic keys comprise at least one of a public key or a private key, and wherein HTS is used natively to enable a payment token for a HowlCard.

18. A computer program product for providing a digital ledger technology (DLT)-based payment platform, the computer program product comprising a non-transitory computer-readable medium having program instructions embodied therewith, the program instructions executable by a processor to cause the processor to:
execute a smart contract on a Hedera distributed ledger network in response to one or more actions satisfying one or more predefined conditions defined by the smart contract, wherein the Hedera distributed ledger network operates on a hashgraph consensus;
train an artificial intelligence (AI) model based on prior historical data to identify and authenticate users and to execute or deny financial transactions;
determine, using the AI model, a confidence level associated with a financial transaction associated with the smart contract;
determine, based on a value of the financial transaction, a confidence requirement applicable to the financial transaction, wherein a first confidence requirement applicable to a first financial transaction having a first value is greater than a second confidence requirement applicable to a second financial transaction having a second value lower than the first value;
authorize execution of, or deny, the financial transaction based on whether the confidence level associated with the financial transaction satisfies the confidence requirement applicable to the financial transaction;
enable, via a payment platform, an existing financial instrument associated with a financial institution to be used for performing the financial transaction associated with the smart contract;
employ, by the payment platform, Hedera Token Service (HTS) to enable payment of the financial transaction via one or more native tokens; and
employ, by the payment platform, Hedera Consensus Service (HCS) to preserve an immutable log of messages associated with the financial transaction, the immutable log having fair consensus and a trusted timestamp.

19. The computer program product of claim 18, wherein the program instructions further cause the processor to build and continuously train the AI model, map, using a classifier, an input attribute vector associated with the financial transaction to a confidence class, and determine an action to be automatically performed based on the confidence class.

20. The computer program product of claim 18, wherein the program instructions further cause the processor to settle funds associated with the financial transaction in real time by moving fiat money from a first financial account to a second financial account based on instructions to settle the funds, and to allow a consumer to authorize the financial transaction using native device capabilities and one or more cryptographic keys.
